(19) United States
(12) Patent Application Publication
(10) Pub. No.: US 2025/0301075 A1
(43) Pub. Date: Sep. 25, 2025

(54) IMAGE FORMING APPARATUS

(71) Applicant: CANON KABUSHIKI KAISHA, Tokyo (JP)

(72) Inventor: SHUJI OBATA, Chiba (JP)

(21) Appl. No.: 19/051,519

(22) Filed: Feb. 12, 2025

(30) Foreign Application Priority Data
Mar. 25, 2024 (JP) 2024-047849

(51) Int. Cl. H04N 1/00

(52) U.S. Cl. CPC H04N 1/00411; H04N 1/00891

(57) ABSTRACT

An image forming apparatus that forms an image on a recording material includes: an apparatus body including an image forming portion configured to form an image on a recording material; an operation panel including a display portion configured to display information regarding image formation, the operation panel being provided in the apparatus body to be movable between an exposed position where the entirety of the display portion is exposed to an outside of the apparatus body and a stored position where the entirety of the display portion is stored in the apparatus body so as not to be visible from the outside of the apparatus body, the operation panel operation panel can be positioned at an intermediate position between the exposed position and the stored position, where a portion of the operation panel is stored in the apparatus body; a state change portion configured to change a state according to the exposed position, the stored position, and the intermediate position of the operation panel; and a controller configured to determine the exposed state, the stored position, or the intermediate position of the operation panel based on the state of the state change portion.

### BACKGROUND OF THE INVENTION

### Field of the Invention

The present invention relates to an image forming apparatus including an operation panel.

### Description of the Related Art

Conventionally, an image forming apparatus that forms an image on a recording medium includes an operation panel including a display for displaying information of a progress status of an image forming operation, various setting contents, or the like. In recent years, in such an image forming apparatus, there has been a trend to increase the size of the operation panel in order to improve the visibility of the display or increase the amount of information to be displayed.

Japanese Patent Application Laid-Open No. 2021-53818 discloses an image forming apparatus in which a portion of a display having flexibility and having a touch panel on a surface thereof is stored in a storage portion, and the display is pulled out from the storage portion as necessary, so that a screen can be enlarged when a large screen is required.

Further, Japanese Patent Application Laid-Open No. 2010-160337 discloses an image forming apparatus including an operation portion that can be stored in the image forming apparatus. The image forming apparatus disclosed in Japanese Patent Application Laid-Open No. 2010-160337 includes a protrusion detection sensor that detects a protruding position of the operation portion protruding to the outside of the image forming apparatus, and a storage detection sensor that detects a stored position of the operation portion stored in the image forming apparatus.

However, Japanese Patent Application Laid-Open No. 2010-160337 has a problem that it is not possible to detect a state where the operation portion is located between the protruding position and the stored position.

### SUMMARY OF THE INVENTION

According to the present invention, an image forming apparatus that forms an image on a recording material includes: an apparatus body including an image forming portion configured to form an image on a recording material; an operation panel including a display portion configured to display information regarding image formation, the operation panel being provided in the apparatus body to be movable between an exposed position to be an exposed state where the entirety of the display portion is exposed to an outside of the apparatus body and a stored position to be a stored state where the entirety of the display portion is stored in the apparatus body so as not to be visible from the outside of the apparatus body, the operation panel can be positioned at an intermediate position between the exposed position and the stored position where a portion of the display is stored in the apparatus body; a state change portion configured to change a state according to the exposed position, the stored position, and the intermediate position of the operation panel; and a controller configured to determine the exposed position, the stored position, or the intermediate position of the operation panel based on the state of the state change portion.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to a first embodiment of the present invention.

FIG. 2 is a block diagram illustrating a configuration of an image forming system including the image forming apparatus according to the first embodiment of the present invention.

FIG. 3 is a block diagram illustrating a configuration of an operation panel of the image forming apparatus according to the first embodiment of the present invention.

FIGS. 4A, 4B, 4C, and 4D are diagrams illustrating operations of the operation panel of the image forming apparatus according to the first embodiment of the present invention.

FIG. 5 is a diagram illustrating a state where the operation panel of the image forming apparatus according to the first embodiment of the present invention is rotated in an exposed state.

FIGS. 6A, 6B, 6C, and 6D are diagrams illustrating a method of detecting a state of the operation panel of the image forming apparatus according to the first embodiment of the present invention.

FIG. 7 is a flowchart of panel state detection processing performed by the image forming apparatus according to the first embodiment of the present invention.

FIGS. 8A, 8B, and 8C are diagrams illustrating a method of detecting a state from an exposed state to a fourth intermediate state of an operation panel of an image forming apparatus according to a second embodiment of the present invention.

FIGS. 9A, 9B, and 9C are diagrams illustrating a method of detecting a state from a fifth intermediate state to a stored state of the operation panel of the image forming apparatus according to the second embodiment of the present invention.

FIG. 10 is a flowchart of panel state detection processing performed by the image forming apparatus according to the second embodiment of the present invention.

FIGS. 11A, 11B, 11C, and 11D are diagrams illustrating a method of detecting a state of an operation panel of an image forming apparatus according to a third embodiment of the present invention.

FIGS. 12A, 12B, 12C, and 12D are diagrams illustrating a method of detecting a state of an operation panel of an image forming apparatus according to a fourth embodiment of the present invention.

FIGS. 13A, 13B, 13C, and 13D are diagrams illustrating a method of detecting a state of an operation panel of an image forming apparatus according to a fifth embodiment of the present invention.

FIG. 14 is a flowchart of panel state detection processing performed by the image forming apparatus according to the fifth embodiment of the present invention.

FIGS. 15A, 15B, 15C, and 15D are diagrams illustrating a method of detecting a state of an operation panel of an image forming apparatus according to a sixth embodiment of the present invention.

FIG. 16 is a flowchart of panel state detection processing performed by the image forming apparatus according to the sixth embodiment of the present invention.

FIGS. 17A, 17B, 17C, 17D, and 17E are perspective views illustrating some members of the image forming apparatus according to the first to fifth embodiments of the present invention.

### DESCRIPTION OF THE EMBODIMENTS

Hereinafter, embodiments will be described in detail with reference to the drawings.

### First Embodiment

### Configuration of Image Forming System

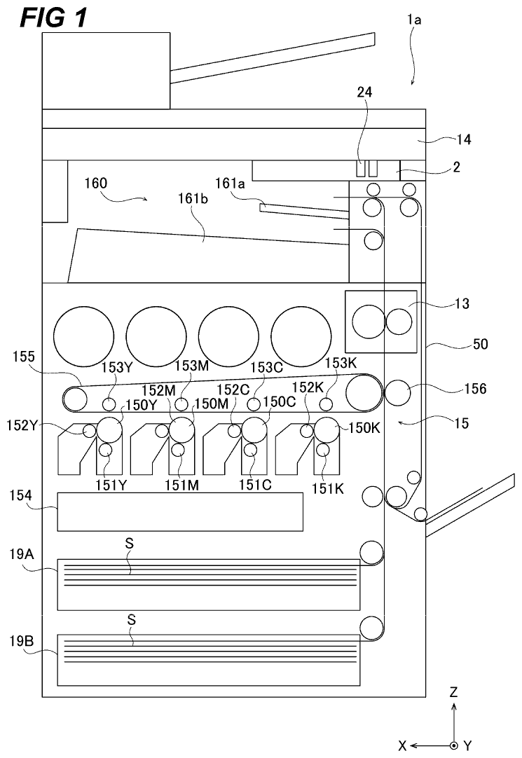

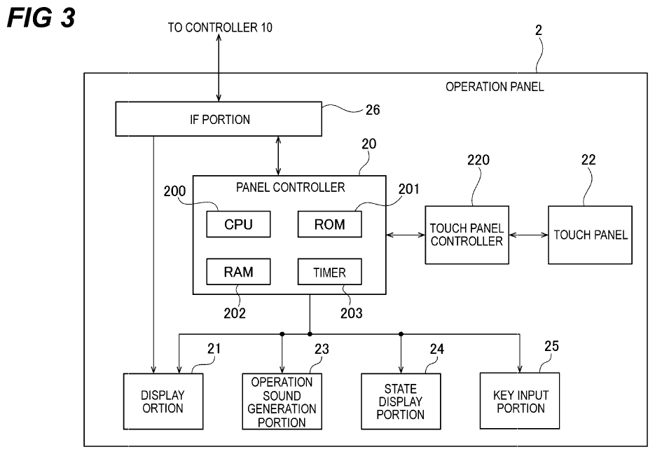

A configuration of an image forming system A according to a first embodiment of the present invention will be described in detail with reference to FIGS. 1 to 3.

The image forming system A includes an image forming apparatus 1a, a processing device 16, and a notification device 17. The image forming system A does not need to include the processing device 16.

The image forming apparatus 1a forms an image on a sheet S as a recording material, and conveys the sheet S on which the image has been formed to the processing device 16 or discharges the sheet S to the outside. The image forming apparatus 1a discharges the sheet S conveyed from the processing device 16 to the outside. Details of the configuration of the image forming apparatus 1a will be described later.

The processing device 16 is connected to the image forming apparatus 1a for the purpose of extending a function as an option. The processing device 16 performs processing set by a user, such as staple processing, punch processing, or bookbinding processing, on the sheet S conveyed from the image forming apparatus 1a, and on which the image has been formed. The processing device 16 conveys the sheet S subjected to the processing set by the user to the image forming apparatus 1a.

The notification device 17 performs notification of the state of the image forming apparatus 1a.

### Configuration of Image Forming Apparatus

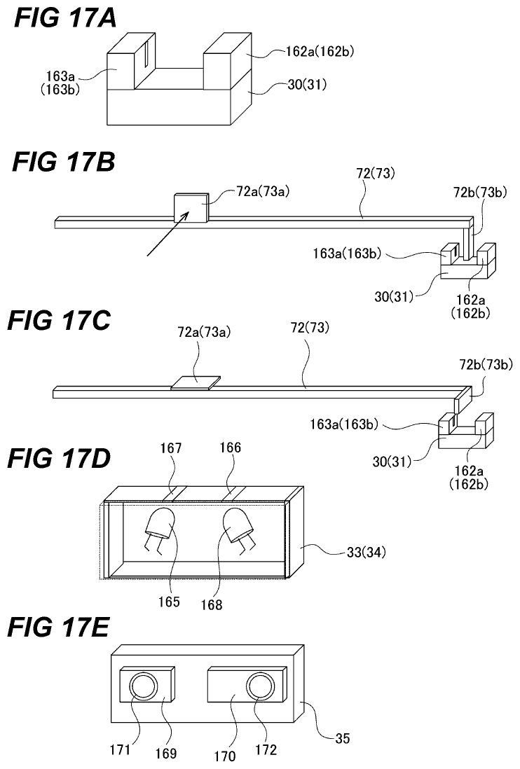

A configuration of the image forming apparatus 1a according to the first embodiment of the present invention will be described in detail with reference to FIGS. 1, 2, 6, and 17A. FIG. 17A is a perspective view of a detection sensor 30 and a detection sensor 31 of the image forming apparatus 1a according to the present embodiment.

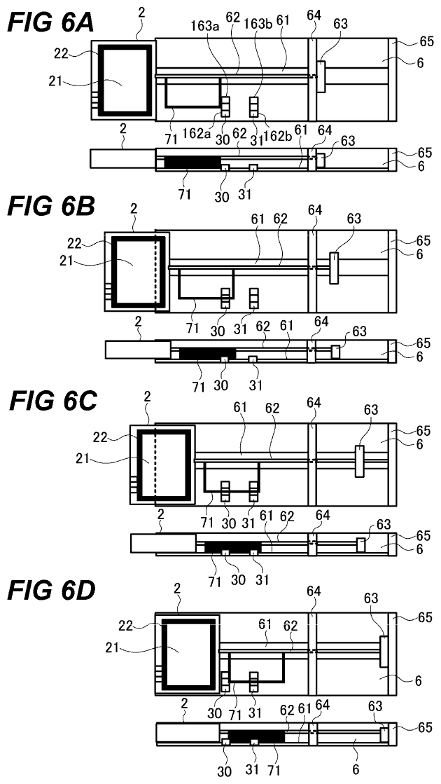

In FIG. 6, FIG. 6A illustrates an exposed state where an operation panel 2 is located at an exposed position. FIG. 6B illustrates a first intermediate state where the operation panel 2 is located at an intermediate position between the exposed position and a stored position and an exposure amount of the operation panel 2 is larger than that in a second intermediate state. FIG. 6C illustrates a second intermediate state where the operation panel 2 is located at the intermediate position and the exposure amount of the operation panel 2 is smaller than that in the first intermediate state. FIG. 6D illustrates a stored state where the operation panel 2 is located at the stored position.

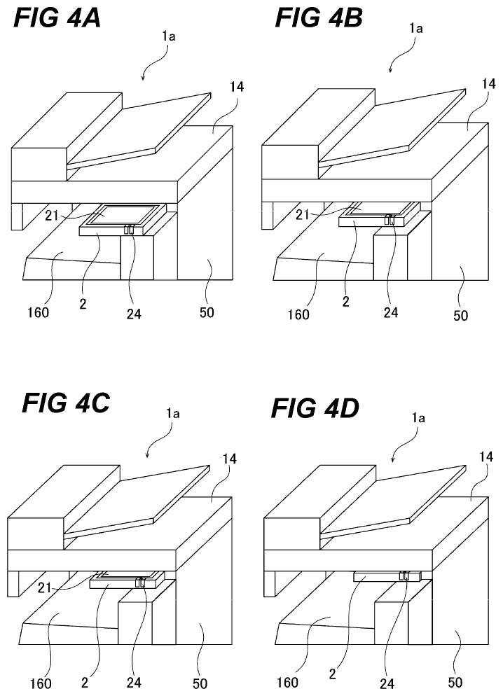

The image forming apparatus 1a includes an operation panel 2, an operation panel storage portion 6, a controller 10, a storage device 11, a power source device 12, a fixing portion 13, a reader 14, an image forming portion 15, a sheet cassette 19A, and a sheet cassette 19B. The image forming apparatus 1a further includes a detection sensor 30, a detection sensor 31, an apparatus body 50, an operation portion rail 61, a shaft portion 62, a fixing member 63, an abutment member 64, an abutment member 65, a light shielding member 71, a sheet discharge tray 161a, and a sheet discharge tray 161b. In FIGS. 1 and 4, the operation panel storage portion 6 is not illustrated.

The operation panel 2 as an operation portion is stored in the operation panel storage portion 6 to be movable in a Y-direction or a direction opposite to the Y-direction, and is rotatable about an axis parallel to the X-direction as a rotation axis in a state of being moved in the Y-direction. The operation panel 2 operates under the control of the controller 10. Details of a configuration of the operation panel 2 will be described later.

The operation panel storage portion 6 is provided in a space below the reader 14 in the apparatus body 50 of the image forming apparatus 1a. The operation panel storage portion 6 is not limited to a configuration of being provided in the space below the reader 14, and may be configured to be provided inside the reader 14 or in a space above the reader 14. In addition, in FIGS. 1 and 4, the operation panel storage portion 6 is not illustrated.

The controller 10 controls the overall operation of the image forming apparatus 1a, the operation of the processing device 16, and the operation of the notification device 17. The controller 10 includes a CPU 100, a memory 101, and a timer 102.

The CPU 100 controls operations of the operation panel 2, the power source device 12, the fixing portion 13, the reader 14, the image forming portion 15, the processing device 16, and the notification device 17 connected to the controller 10. The CPU 100 reads and executes a program 110 stored in the storage device 11 to control the reader 14, the image forming portion 15, the processing device 16, or the like while using the memory 101.

The CPU 100 performs image processing on image data input from the reader 14, stores the image data subjected to the image processing in the storage device 11, and performs image forming processing of transferring the image data to the image forming portion 15, thereby forming an image on a sheet S. The CPU 100 reads display image data stored in the storage device 11 from the storage device 11 and transmits the display image data to the operation panel 2, thereby displaying an image on the operation panel 2.

The CPU 100 performs mode setting processing by using the timer 102. In a mode setting processing, the CPU 100 shifts the image forming apparatus 1a from a standby mode to a sleep mode with low power consumption, according to a count value counted by the timer 102.

The CPU 100 performs panel state detection processing (which will be described later) of determining the state of the operation panel 2 based on electrical signals input from the detection sensor 30 and the detection sensor 31. The CPU 100 controls a power supply destination by the power source device 12 according to the determined state of the operation panel 2. The CPU 100 generates a control signal for controlling display of a display portion 21 (which will be described later) of the operation panel 2 according to the determined state of the operation panel 2, and outputs the generated control signal to the operation panel 2.

The memory 101 temporarily stores data associated with the execution of the program 110 by the CPU 100.

The timer 102 counts the count value by performing clocking when the CPU 100 performs various types of processing, under the control of the CPU 100.

The storage device 11 stores various programs 110 related to the control of the image forming apparatus 1a, display image data, print data, and the like. Here, the various programs 110 stored in the storage device 11 are a software group caused to function to perform various types of processing by the controller 10. The display image data stored in the storage device 11 is data for displaying an image on the operation panel 2.

The power source device 12 as a power supply portion receives power supply from a commercial power source via an outlet plug (not illustrated). The power source device 12 supplies power supplied from the commercial power source to each device of the image forming system A under the control of the CPU 100.

The fixing portion 13 fixes a toner image on a sheet S by performing heating and pressurizing processing on the sheet S on which the toner image conveyed by an intermediate transfer belt 155 and a secondary transfer roller 156 has been secondarily transferred. The fixing portion 13 conveys the sheet S on which the toner image has been fixed toward the sheet discharge tray 161a or the sheet discharge tray 161b.

The reader 14 optically reads an image of an original placed on a glass surface (not illustrated), converts the image into image data, and outputs the converted image data to the image forming portion 15.

The image forming portion 15 performs image forming processing of forming an image on a sheet S fed from the sheet cassette 19A or the sheet cassette 19B based on the image data input from the reader 14. The image forming portion 15 includes photosensitive drums 150Y, 150M, 150C, and 150K, charging devices 151Y, 151M, 151C, and 151K, and developing devices 152Y, 152M, 152C, and 152K. The image forming portion 15 includes primary transfer rollers 153Y, 153M, 153C, and 153K, a laser scanner unit 154, an intermediate transfer belt 155, and a secondary transfer roller 156.

The photosensitive drums 150Y, 150M, 150C, and 150K are rotated by driving of a driving device (not illustrated). Toner images are formed on the photosensitive drums 150Y, 150M, 150C, and 150K by the charging devices 151Y, 151M, 151C, and 151K, the developing devices 152Y, 152M, 152C, and 152K, and the laser scanner unit 154.

The charging devices 151Y, 151M, 151C, and 151K charge the surfaces of the photosensitive drums 150Y, 150M, 150C, and 150K.

The developing device 152Y causes a yellow toner to adhere to an electrostatic latent image formed on the surface of the photosensitive drum 150Y by the laser scanner unit 154 to form a yellow toner image on the surface of the photosensitive drum 150Y.

The developing device 152M causes a magenta toner to adhere to an electrostatic latent image formed on the surface of the photosensitive drum 150M by the laser scanner unit 154 to form a magenta toner image on the surface of the photosensitive drum 150M.

The developing device 152C causes a cyan toner to adhere to an electrostatic latent image formed on the surface of the photosensitive drum 150C by the laser scanner unit 154 to form a cyan toner image on the surface of the photosensitive drum 150C.

The developing device 152K causes a black toner to adhere to an electrostatic latent image formed on the surface of the photosensitive drum 150K by the laser scanner unit 154 to form a black toner image on the surface of the photosensitive drum 150K.

When a primary transfer bias is applied, the primary transfer roller 153Y primarily transfers the yellow toner image formed on the surface of the photosensitive drum 150Y by the developing device 152Y to the intermediate transfer belt 155.

When a primary transfer bias is applied, the primary transfer roller 153M primarily transfers the magenta toner image formed on the surface of the photosensitive drum 150M by the developing device 152M to the intermediate transfer belt 155. At this time, the primary transfer roller 153M primarily transfers the magenta toner image by superimposing the magenta toner image on the yellow toner image on the intermediate transfer belt 155.

When a primary transfer bias is applied, the primary transfer roller 153C primarily transfers the cyan toner image formed on the surface of the photosensitive drum 150C by the developing device 152C to the intermediate transfer belt 155. At this time, the primary transfer roller 153C primarily transfers the cyan toner image by superimposing the cyan toner image on the yellow and magenta toner images on the intermediate transfer belt 155.

When a primary transfer bias is applied, the primary transfer roller 153K primarily transfers the black toner image formed on the surface of the photosensitive drum 150K by the developing device 152K to the intermediate transfer belt 155. At this time, the primary transfer roller 153K primarily transfers the black toner image by superimposing the black toner image on the yellow, magenta, and cyan toner images on the intermediate transfer belt 155.

Image data from the reader 14 or image data transmitted from an external device (not illustrated) via a network is input to the laser scanner unit 154. The laser scanner unit 154 irradiates the surfaces of the photosensitive drums 150Y, 150M, 150C, and 150K charged by the charging devices 151Y, 151M, 151C, and 151K with laser light according to the input image data. The laser scanner unit 154 irradiates the surfaces of the photosensitive drums 150Y, 150M, 150C, and 150K with laser light to form electrostatic latent images on the surfaces of the photosensitive drums 150Y, 150M, 150C, and 150K.

The toner images are superimposed and primarily transferred by the primary transfer rollers 153Y, 153M, 153C, and 153K, thereby forming a full-color toner image on the intermediate transfer belt 155.

The secondary transfer roller 156 forms a secondary transfer portion together with the intermediate transfer belt 155. When a secondary transfer bias is applied, the secondary transfer roller 156 secondarily transfers the full-color toner image on the intermediate transfer belt 155 to the sheet S fed from the sheet cassette 19A or the sheet cassette 19B in the secondary transfer portion. The secondary transfer roller 156 conveys the sheet S to which the full-color toner image has been secondarily transferred to the fixing portion 13 together with the intermediate transfer belt 155.

A sheet S is accommodated in the sheet cassette 19A.

A sheet S is accommodated in the sheet cassette 19B.

As illustrated in FIG. 6, the detection sensor 30 as a state change portion and a first state change portion is provided in the operation panel storage portion 6, and the state changes according to the position of the operation panel 2. As illustrated in FIG. 17A, the detection sensor 30 is a photosensor such as a photointerrupter including a light receiving portion 162a and a light emitting portion 163a.

The light receiving portion 162a includes a phototransistor (Ptr) (not illustrated) therein. In a transmissive state where there is no light shielding member 71 between the light emitting portion 163a and the light receiving portion 162a, the light receiving portion 162a receives light emitted from the light emitting portion 163a to output a Low-level signal to the controller 10. In a light shielding state where the light shielding member 71 is provided between the light emitting portion 163a and the light receiving portion 162a, the light receiving portion 162a cannot receive the light emitted from the light emitting portion 163a, and thus, outputs a High-level signal to the controller 10.

The light emitting portion 163a includes an LED (not illustrated) therein. The light emitting portion 163a emits light from the LED.

The detection sensor 31 as the state change portion and a second state change portion is provided in the operation panel storage portion 6 and is provided at a position different from the detection sensor 30 in the movement direction of the operation panel 2, and the state changes according to the position of the operation panel 2. The detection sensor 30 and the detection sensor 31 are arranged along the movement direction of the operation panel 2. The detection sensor 31 is a photosensor such as a photointerrupter including a light receiving portion 162b and a light emitting portion 163b.

The light receiving portion 162b includes a phototransistor (not illustrated) inside. In the transmissive state where there is no light shielding member 71 between the light emitting portion 163b and the light receiving portion 162b, the light receiving portion 162b receives light emitted from the light emitting portion 163b to output a Low-level signal to the controller 10. In the light shielding state where the light shielding member 71 is provided between the light emitting portion 163b and the light receiving portion 162b, the light receiving portion 162b cannot receive the light emitted from the light emitting portion 163b, and thus, outputs a High-level signal to the controller 10.

The light emitting portion 163b includes an LED (not illustrated) therein. The light emitting portion 163b emits light from the LED.

The apparatus body 50 includes the fixing portion 13, the image forming portion 15, the sheet cassette 19A, the sheet cassette 19B, the sheet discharge tray 161a, the sheet discharge tray 161b, and the like. In the sheet discharge tray 161a, the sheet S to which the toner image conveyed by the fixing portion 13 is fixed is discharged as it is via the processing device 16 or not via the processing device 16. In the sheet discharge tray 161b, the sheet S to which the toner image conveyed by the fixing portion 13 is fixed is discharged as it is via the processing device 16 or not via the processing device 16.

As illustrated in FIG. 6, the operation portion rail 61 is provided in the operation panel storage portion 6. By sliding the operation panel 2 in the Y-direction or a direction opposite to the Y-direction, the operation portion rail 61 causes the operation panel 2 to be stored in the operation panel storage portion 6 or to be exposed from the operation panel storage portion 6.

The operation panel 2 is connected to the shaft portion 62. The shaft portion 62 moves together with the operation panel 2.

As illustrated in FIG. 6, the fixing member 63 is connected to the shaft portion 62. The fixing member 63 moves together with the operation panel 2 and the shaft portion 62.

The abutment member 64 is provided at a position capable of abutting on the fixing member 63. The abutment member 64 abuts on the fixing member 63 to regulate the movement of the operation panel 2 in the Y-direction (the leftward direction in FIG. 6A).

The abutment member 65 is provided at a position capable of abutting on the fixing member 63. The abutment member 65 abuts on the fixing member 63 to regulate the movement of the operation panel 2 in the direction (the rightward direction in FIG. 6D) opposite to the Y-direction.

The light shielding member 71 is provided at the shaft portion 62. The light shielding member 71 moves together with the shaft portion 62 to pass between the light receiving portion 162a and the light emitting portion 163a or between the light receiving portion 162b and the light emitting portion 163b.

### Configuration of Operation Panel

A configuration of the operation panel 2 of the image forming apparatus 1a according to the first embodiment of the present invention will be described in detail with reference to FIGS. 1 to 3.

The operation panel 2 includes a panel controller 20, a display portion 21, a touch panel 22, an operation sound generation portion 23, a state display portion 24, a key input portion 25, an IF portion 26, and a touch panel controller 220.

The panel controller 20 controls the overall operation of the operation panel 2 by transmitting and receiving an electric signal to and from the controller 10 via the IF portion 26. The panel controller 20 includes a CPU 200, a ROM 201, a RAM 202, and a timer 203.

The CPU 200 performs various types of arithmetic processing by executing a control program stored in the ROM 201, according to a control signal input from the CPU 100 via the IF portion 26. The CPU 200 executes the control program to control the operations of the display portion 21, the operation sound generation portion 23, the state display portion 24, the key input portion 25, the IF portion 26, and the touch panel controller 220.

The CPU 200 performs control to perform switching between a display image related to information stored in advance in the ROM 201 and a display image of display image data received from the CPU 100 via the IF portion 26 and display the switched display image on the display portion 21. The CPU 200 calculates coordinates of a touch position on the touch panel 22 based on coordinate data input from the touch panel controller 220, and outputs an electric signal corresponding to a calculation result of the coordinates of the touch position to the controller 10 of the image forming apparatus 1a via the IF portion 26. When the operation of the user on the touch panel 22 is desired to be invalidated, the CPU 200 does not output the electric signal corresponding to the calculation result of the coordinates of the touch position.

The CPU 200 changes a light emission state of the state display portion 24 based on a control signal input from the CPU 100 via the IF portion 26. Specifically, the CPU 200 controls the light emission state of the state display portion 24 to emit light with a first light quantity or a second light quantity that is a light quantity larger than the first light quantity, based on the control signal input from the CPU 100 via the IF portion 26.

The ROM 201 stores various programs such as a control program related to control of the operation panel 2, and information and data related to connection with the image forming apparatus 1a. Here, the information related to the control is information for establishing connection with the image forming apparatus 1a, information acquired from the image forming apparatus 1a, and the like. The information acquired from the image forming apparatus 1a includes information regarding the state of the image forming apparatus 1a such as a standby mode, a sleep mode, or error detection, and count information such as the number of printed sheets.

The RAM 202 is used as a work area at the time of calculation by the CPU 200, and temporarily stores data.

The timer 203 counts a count value by performing clocking when the CPU 200 performs various types of processing under the control of the CPU 200.

The display portion 21 displays an image of image data stored in advance in the ROM 201 or an image of image data input from the controller 10 via the IF portion 26 under the control of the panel controller 20. Here, the image displayed on the display portion 21 includes an image of information related to image formation such as the number of sheets on which an image is formed or the size of the sheet S on which an image is formed, an image of an input key for making settings related to image reading such as the size of an original, and the like. As described above, the image of the image data stored in the ROM 201 of the operation panel 2 and the image of the image data received by the operation panel 2 from the controller 10 are switched and displayed on the display portion 21 by the control of the CPU 200.

The touch panel 22 as the operation portion is disposed to overlap the display portion 21, and allows a screen of the display portion 21 to be visually recognized through the touch panel. The touch panel 22 is connected to the panel controller 20 via the touch panel controller 220. The touch panel 22 can be operated by touch of the user, detects a touch operation of the user on an image displayed on the display portion 21, and outputs an electric signal corresponding to a detection result to the touch panel controller 220.

The operation sound generation portion 23 emits an operation sound corresponding to an operation on the touch panel 22 under the control of the panel controller 20.

The state display portion 24 is an LED or the like that notifies the user of the state of the image forming apparatus 1a, and is provided at a position where the operation panel 2 can be visually recognized from the outside in a state where the operation panel 2 is stored in the apparatus body 50 as illustrated in FIG. 4. The state display portion 24 is turned on or off according to the state of the image forming apparatus 1a and changes the light emission state, under the control of the panel controller 20. The state display portion 24 includes LEDs of a plurality of colors such as red and green, and notifies the user of the state of the image forming apparatus 1a by changing the color or lighting pattern according to the state of the image forming apparatus 1a. Here, the state of the image forming apparatus 1a is a state where a job is being executed or a state where an error such as paper shortage or jam has occurred.

The key input portion 25 is provided at a place other than the place where the display portion 21 is provided on the operation panel 2, and is a hard key including a key for starting a job of the image forming apparatus 1a and a numeric keypad for inputting a numerical value. The key input portion 25 receives a setting of the image forming apparatus 1a or an input of a job command by the user with the key or the numeric keypad, and outputs an electric signal corresponding to the received input to the panel controller 20.

The IF portion 26 transmits and receives an electric signal between the CPU 100 of the controller 10 and the CPU 200 of the panel controller 20.

The touch panel controller 220 operates under the control of the panel controller 20. The touch panel controller 220 detects a touch position on the touch panel 22 by the user based on the electric signal input from the touch panel 22, and outputs coordinate data of the detected touch position to the CPU 200.

In the operation panel 2 having the above configuration, the user can perform input or the like by touching an input portion or a key of a button displayed on the display portion 21 with a finger via the touch panel 22. As a result, it is possible to perform settings related to image formation such as setting of the number of sheets on which an image is formed or the size of the sheet S, or settings related to image reading such as setting of the size of an original.

### Operation of Image Forming Apparatus

The operation of the image forming apparatus 1a according to the first embodiment of the present invention will be described in detail with reference to FIGS. 1 to 3.

When an image forming job is input from the touch panel 22 of the operation panel 2, the controller 10 starts an image forming operation by receiving the image forming job from the touch panel 22 via the touch panel controller 220, the panel controller 20, and the IF portion 26.

When the image forming operation is started, a sheet S stored in either the sheet cassette 19A or the sheet cassette 19B is sent to the secondary transfer portion formed by the intermediate transfer belt 155 and the secondary transfer roller 156.

In the image forming portion 15, the surface of the photosensitive drum 150Y is charged by the charging device 151Y.

Then, the laser scanner unit 154 irradiates the surface of the photosensitive drum 150Y with laser light according to image data of an original read by the reader 14 or image data received from an external device (not illustrated) via a network. As a result, an electrostatic latent image is formed on the surface of the photosensitive drum 150Y.

Then, the developing device 152Y causes a yellow toner to adhere to the electrostatic latent image formed on the surface of the photosensitive drum 150Y to form a yellow toner image on the surface of the photosensitive drum 150Y.

Then, the toner image formed on the surface of the photosensitive drum 150Y is primarily transferred to the intermediate transfer belt 155 by the primary transfer roller 153Y.

By a similar process, magenta, cyan, and black toner images are formed on the photosensitive drums 150M, 150C, and 150K. By applying a primary transfer bias to the primary transfer rollers 153M, 153C, and 153K, these toner images are transferred in a superimposed manner on the yellow toner image on the intermediate transfer belt 155. As a result, a full-color toner image corresponding to an image signal is formed on the surface of the intermediate transfer belt 155.

Then, the full-color toner image formed on the intermediate transfer belt 155 is conveyed to the secondary transfer portion by rotation of the intermediate transfer belt 155.

Then, the full-color toner image formed on the intermediate transfer belt 155 conveyed to the secondary transfer portion is transferred to the sheet S conveyed from the sheet cassette 19A or the sheet cassette 19B in the secondary transfer portion.

The sheet S to which the toner image has been transferred is conveyed to the fixing portion 13, and is subjected to heating and pressurizing processing in the fixing portion 13 to fix the toner image.

Then, the sheet S to which the toner image has been fixed is sent to the processing device 16. When the user designates processing such as stapling processing, punching processing, or bookbinding processing, the sheet S sent to the processing device 16 is discharged to the sheet discharge tray 161a in a sheet discharge region 160 in a state of being subjected to the designated processing. Further, the sheet S to which the toner image has been fixed is discharged as it is to the sheet discharge tray 161b in the sheet discharge region 160 when the user does not designate processing or when the processing device 16 is not connected.

### Control According to State of Operation Panel

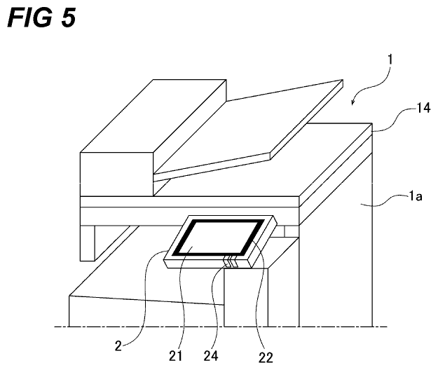

Control according to the state of the operation panel 2 of the image forming apparatus 1a according to the first embodiment of the present invention will be described in detail with reference to FIGS. 4 and 5. In FIGS. 4 and 5, the key input portion 25 on the operation panel 2 is not illustrated.

In FIG. 4, FIG. 4A illustrates an exposed state where the operation panel 2 is located at an exposed position. FIG. 4B illustrates a first intermediate state where the operation panel 2 is located at an intermediate position. FIG. 4C illustrates a second intermediate state where the operation panel 2 is located at an intermediate position. FIG. 4D illustrates a stored state where the operation panel 2 is located at a stored position.

Here, the exposed position to be the exposed state is a position where the entirety of the display portion 21, the touch panel 22, and the key input portion 25 are exposed from the apparatus body 50. The stored position to be the stored state is a position at which the entirety of the display portion 21, the touch panel 22, and the key input portion 25 are stored in the apparatus body 50 such that the entirety of the display portion 21, the touch panel 22, and the key input portion 25 cannot be visually recognized from the outside.

In the exposed state where the operation panel 2 is located at the exposed position, the entirety of the display portion 21 is visually recognizable from the outside. In the exposed state where the operation panel 2 is located at the exposed position, the entirety of the touch panel 22 is in an operable state of a touch operation or the like by the user, and the entirety of the key input portion 25 is in an operable state of a pressing operation or the like.

In the stored state where the operation panel 2 is located at the stored position, the entirety of the touch panel 22 cannot be operated by the user, and the entirety of the key input portion 25 cannot be operated by the user.

When the operation panel 2 is in the exposed state illustrated in FIG. 4A, the touch panel 22 is visible. When the operation panel 2 is in the stored state illustrated in FIG. 4D, the touch panel 22 is in a state of being invisible. Further, when the operation panel 2 is in the first intermediate state illustrated in FIG. 4B and the second intermediate state illustrated in FIG. 4C, a portion of the touch panel 22 is visible, and the operation panel 2 is in neither the exposed state nor the stored state. As illustrated in FIG. 5, the operation panel 2 is rotatable about a rotation axis parallel to the X-direction in the exposed state.

As is clear from comparison among FIGS. 4A to 4D, by storing the operation panel 2 in the operation panel storage portion 6, it is possible to widen the sheet discharge region 160 as compared with a case where the operation panel 2 is not stored in the operation panel storage portion 6. As a result, in a state where the operation panel 2 is stored in the operation panel storage portion 6, it is possible to easily take out the sheet S discharged to the sheet discharge tray 161a or the sheet discharge tray 161b in the sheet discharge region 160.

When determining that the operation panel 2 is in the exposed state, the first intermediate state, the second intermediate state, or the stored state, the CPU 100 performs control to supply power from the power source device 12 to the display portion 21 or control to stop the supply of power, according to each determined state. For example, when the operation panel 2 is in the stored state, the CPU 100 performs control to stop the supply of power from the power source device 12 to the display portion 21, whereby it is possible to save power.

When determining that the operation panel 2 is in the exposed state, the first intermediate state, the second intermediate state, or the stored state, the CPU 100 performs control to supply power from the power source device 12 to the touch panel 22 or control to stop the supply of power, according to each determined state. For example, when the operation panel 2 is in the first intermediate state or the second intermediate state, the CPU 100 performs control to stop the supply of power from the power source device 12 to the touch panel 22, thereby turning OFF the touch panel 22. As a result, even if the user touches the touch panel 22 when the operation panel 2 is pulled out of the apparatus body 50, the touch panel 22 does not operate, and thus it is possible to reduce the operation of the image forming apparatus 1a not intended by the user.

Further, when determining that the operation panel 2 is in the exposed state, the first intermediate state, the second intermediate state, or the stored state, the CPU 100 performs control to change a display mode of the image displayed on the display portion 21 according to each determined state.

For example, when the operation panel 2 is in the first intermediate state or the second intermediate state, the display region of the display portion 21 is smaller than when the operation panel 2 is in the exposed state. As a result, the CPU 100 performs control to make the size of an icon displayed on the display portion 21 of the operation panel 2 in the first intermediate state or the second intermediate state smaller than the size of the icon displayed on the display portion 21 of the operation panel 2 in the exposed state. Alternatively, the CPU 100 performs control to make the number of icons displayed on the display portion 21 of the operation panel 2 in the first intermediate state or the second intermediate state smaller than the number of icons displayed on the display portion 21 of the operation panel 2 in the exposed state.

As described above, the CPU 100 performs control to change the size of the icon or the number of icons according to the display region of the display portion 21. As a result, even though the area of the display region of the display portion 21 changes, it is possible to suppress deterioration in usability by changing the display mode.

### State Detection Method for Operation Panel

A state detection method for the operation panel 2 of the image forming apparatus 1a according to the first embodiment of the present invention will be described in detail with reference to FIG. 6. In FIG. 6, the key input portion 25 on the operation panel 2 is not illustrated.

The operation panel 2 moves in one direction along the operation portion rail 61 to reach the stored position to be in the stored state through the first intermediate state and the second intermediate state from the exposed position to be in the exposed state. The operation panel 2 moves in a direction opposite to the one direction along the operation portion rail 61 to reach the exposed position to be in the exposed state through the second intermediate state and the first intermediate state from the stored position to be in the stored state.

When the operation panel 2 moves in the direction opposite to the Y-direction which is a push-in direction, the fixing member 63 and the light shielding member 71 move in a push-in direction in conjunction with the movement of the operation panel 2. Further, when the operation panel 2 moves in the Y-direction which is a pull-out direction, the fixing member 63 and the light shielding member 71 move in the pull-out direction in conjunction with the movement of the operation panel 2.

When the operation panel 2 is pulled out to the exposed position to be in the exposed state, the fixing member 63 abuts on the abutment member 64 to regulate the movement of the operation panel 2 from the exposed position in the pull-out direction. Further, when the operation panel 2 is pushed to the stored position to be in the stored state, the fixing member 63 abuts on the abutment member 65 to regulate the movement of the operation panel 2 from the stored position in the push-in direction.

The states of the detection sensor 30 and the detection sensor 31 change from the transmissive state to the light shielding state or from the light shielding state to the transmissive state by the light shielding member 71 that moves in conjunction with the movement of the operation panel 2. The CPU 100 determines the position and the state of the operation panel 2 based on the states of the detection sensor 30 and the detection sensor 31.

Specifically, when the operation panel 2 is in the exposed state illustrated in FIG. 6A, the light shielding member 71 is located on the pull-out direction side with respect to the detection sensor 30 and the detection sensor 31, so that the detection sensor 30 and the detection sensor 31 are in the transmissive state. The detection sensor 30 in the transmissive state does not detect the light shielding member 71 because light emitted from the light emitting portion 163a is received by the light receiving portion 162a without being blocked by the light shielding member 71. The detection sensor 31 in the transmissive state does not detect the light shielding member 71 because light emitted from the light emitting portion 163b is received by the light receiving portion 162b without being blocked by the light shielding member 71.

As a result, the detection sensor 30 and the detection sensor 31 output a Low-level signal to the CPU 100. When the Low-level signal is input from the detection sensor 30 and the detection sensor 31, the CPU 100 detects that the detection sensor 30 and the detection sensor 31 are in the transmissive state, and determines that the operation panel 2 is in the exposed state.

When the operation panel 2 is in the first intermediate state illustrated in FIG. 6B, the light shielding member 71 brings the detection sensor 30 into the light shielding state and brings the detection sensor 31 into the transmissive state. The detection sensor 30 in the light shielding state detects the light shielding member 71 by the light shielding member 71 shielding the light emitted from the light emitting portion 163a. The detection sensor 31 in the transmissive state does not detect the light shielding member 71 because the light emitted from the light emitting portion 163b is received by the light receiving portion 162b without being blocked by the light shielding member 71.

As a result, the detection sensor 30 outputs a High-level signal to the CPU 100, and the detection sensor 31 outputs a Low-level signal to the CPU 100. The CPU 100 detects that the detection sensor 30 is in the light shielding state when the High-level signal is input from the detection sensor 30, and detects that the detection sensor 31 is in the transmissive state when the Low-level signal is input from the detection sensor 31. As a result, the CPU 100 determines that the operation panel 2 is in the first intermediate state.

When the operation panel 2 is in the second intermediate state illustrated in FIG. 6C, the light shielding member 71 brings the detection sensor 30 and the detection sensor 31 into the light shielding state. The detection sensor 30 in the light shielding state detects the light shielding member 71 by the light shielding member 71 shielding the light emitted from the light emitting portion 163a. The detection sensor 31 in the light shielding state detects the light shielding member 71 by the light shielding member 71 shielding the light emitted from the light emitting portion 163b.

As a result, the detection sensor 30 and the detection sensor 31 output a High-level signal to the CPU 100. When the High-level signal is input from the detection sensor 30 and the detection sensor 31, the CPU 100 detects that the detection sensor 30 and the detection sensor 31 are in the light shielding state, and determines that the operation panel 2 is in the second intermediate state.

When the operation panel 2 is in the stored state illustrated in FIG. 6D, the light shielding member 71 brings the detection sensor 30 into the transmissive state and brings the detection sensor 31 into the light shielding state. The detection sensor 30 in the transmissive state does not detect the light shielding member 71 because light emitted from the light emitting portion 163a is received by the light receiving portion 162a without being blocked by the light shielding member 71. The detection sensor 31 in the light shielding state detects the light shielding member 71 by the light shielding member 71 shielding the light emitted from the light emitting portion 163b.

As a result, the detection sensor 30 outputs a Low-level signal to the CPU 100, and the detection sensor 31 outputs a High-level signal to the CPU 100. The CPU 100 detects that the detection sensor 30 is in the transmissive state when the Low-level signal is input from the detection sensor 30, and detects that the detection sensor 31 is in the light shielding state when the High-level signal is input from the detection sensor 31. As a result, the CPU 100 determines that the operation panel 2 is in the stored state.

As described above, since the position and the state of the operation panel 2 are detected in a digital format by the detection sensor 30 and the detection sensor 31 which are photosensors, it is possible to suppress erroneous detection due to the influence of disturbance or the like.

### Panel State Detection Processing

Panel state detection processing performed by the image forming apparatus 1a according to the first embodiment of the present invention will be described in detail with reference to FIG. 6.

The panel state detection processing illustrated in FIG. 6 is started at a timing when the main power source of the image forming apparatus 1a is turned on. In FIG. 6, the detection of the light shielding member 71 by each of the detection sensor 30 and the detection sensor 31 is described as ON.

First, the CPU 100 determines whether or not the detection sensor 30 detects the light shielding member 71 (whether or not it is ON) (S101).

When the detection sensor 30 does not detect the light shielding member 71 (Step S101: No), the CPU 100 determines whether or not the detection sensor 31 detects the light shielding member 71 (S102).

When the detection sensor 31 does not detect the light shielding member 71 (Step S102: No), the CPU 100 determines that the operation panel 2 is in the exposed state (S103), and then, ends the panel state detection processing.

On the other hand, when the detection sensor 31 detects the light shielding member 71 in the process of Step S102 (Step S102: Yes), the CPU 100 determines that the operation panel 2 is in the stored state (S104), and then, ends the panel state detection processing.

When the detection sensor 30 detects the light shielding member 71 in the process of Step S101 (Step S101: Yes), the CPU 100 determines whether or not the detection sensor 31 detects the light shielding member 71 (S105).

When the detection sensor 31 does not detect the light shielding member 71 (Step S105: No), the CPU 100 determines that the operation panel 2 is in the first intermediate state (S106), and then ends the panel state detection processing.

On the other hand, when the detection sensor 31 detects the light shielding member 71 in the process of Step S105 (Step S105: Yes), the CPU 100 determines that the operation panel 2 is in the second intermediate state (S107), and then ends the panel state detection processing.

In the present embodiment, the detection sensor 30 and the detection sensor 31 whose states change according to the exposed position, the stored position, and the intermediate position of the operation panel 2 are provided. In addition, the CPU 100 that determines the exposed state, the stored state, or the intermediate state of the operation panel 2 based on changes in the states of the detection sensor 30 and the detection sensor 31 is provided. As a result, it is possible to detect that the operation panel 2 is located at the stored position or the exposed position and to detect that the operation panel 2 is located between the exposed position and the stored position.

### Second Embodiment

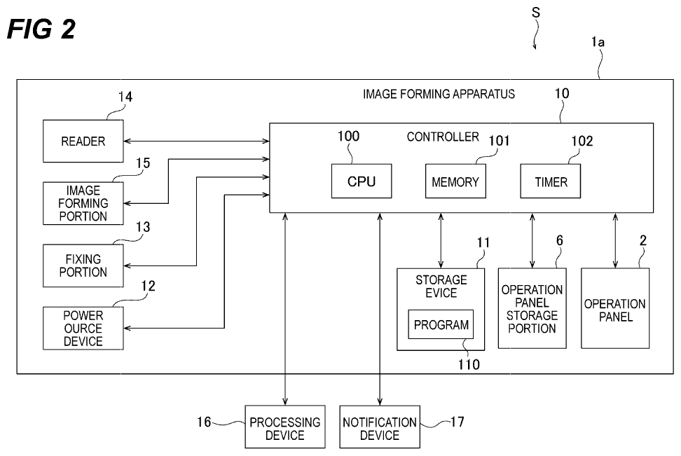

A configuration of an image forming system according to a second embodiment of the present invention is the same as that in FIG. 2, and thus the description thereof will be omitted.

### Configuration of Image Forming Apparatus

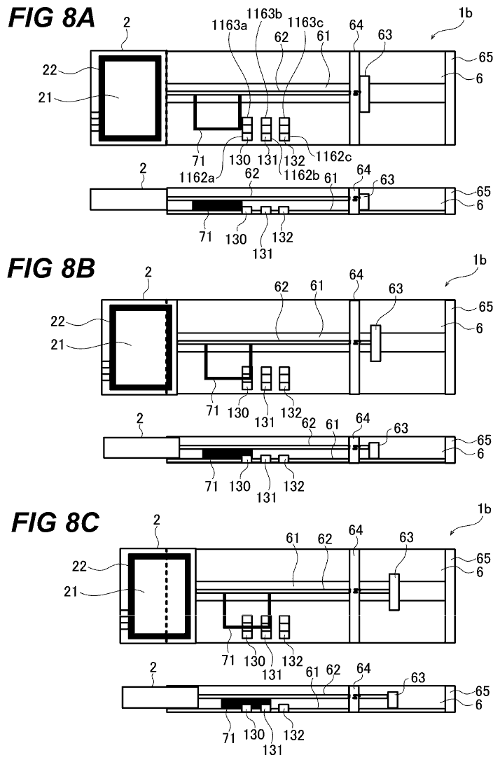

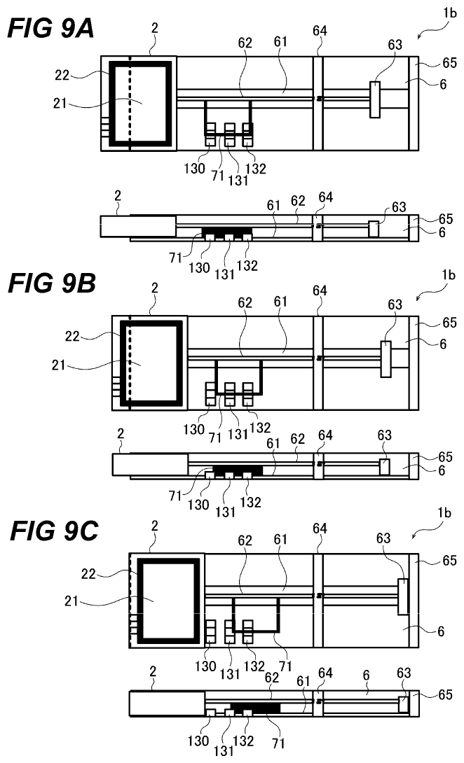

A configuration of an image forming apparatus 1b according to the second embodiment of the present invention will be described in detail with reference to FIGS. 8 and 9. In FIGS. 8 and 9, the same components as those in FIG. 6 are denoted by the same reference signs, and the description thereof will be omitted. The configuration of the image forming apparatus 1b according to the present embodiment other than the components in FIGS. 8 and 9 is the same as that of FIGS. 1 to 3, and thus illustration and description thereof will be omitted. Further, in FIGS. 8 and 9, the key input portion 25 on the operation panel 2 is not illustrated.

In FIG. 8, FIG. 8A illustrates the exposed state where an operation panel 2 is located at the exposed position. FIG. 8B illustrates a third intermediate state where the operation panel 2 is located at an intermediate position between the exposed position and the stored position and the exposure amount of the operation panel 2 is larger than that in a fourth intermediate state. FIG. 8C illustrates the fourth intermediate state where the operation panel 2 moves from the intermediate position illustrated in FIG. 8B in a direction further approaching the stored position and is located at the intermediate position, and the exposure amount of the operation panel 2 is larger than that in a fifth intermediate state.

In FIG. 9, FIG. 9A illustrates the fifth intermediate state where the operation panel 2 moves from the intermediate position illustrated in FIG. 8C in the direction further approaching the stored position and is located at the intermediate position, and the exposure amount of the operation panel 2 is larger than that in a sixth intermediate state. FIG. 9B illustrates the sixth intermediate state where the operation panel 2 moves from the intermediate position illustrated in FIG. 9A in the direction further approaching the stored position and is located at the intermediate position, and the exposure amount of the operation panel 2 is smaller than that in the fifth intermediate state. FIG. 9C illustrates the stored state where the operation panel 2 is located at the stored position.

The image forming apparatus 1b includes the operation panel 2, an operation panel storage portion 6, a controller 10, a storage device 11, a power source device 12, a fixing portion 13, a reader 14, an image forming portion 15, a sheet cassette 19A, and a sheet cassette 19B. The image forming apparatus 1b further includes an operation portion rail 61, a shaft portion 62, a fixing member 63, an abutment member 64, an abutment member 65, and a light shielding member 71. The image forming apparatus 1b further includes a detection sensor 130, a detection sensor 131, a detection sensor 132, a sheet discharge tray 161a, and a sheet discharge tray 161b.

The controller 10 controls the overall operation of the image forming apparatus 1b, the operation of a processing device 16, and the operation of a notification device 17.

The storage device 11 stores various programs 110 related to the control of the image forming apparatus 1b, display image data, print data, and the like.

In a mode setting processing, the CPU 100 shifts the image forming apparatus 1b from a standby mode to a sleep mode with low power consumption, according to a count value counted by a timer 102. The CPU 100 performs panel state detection processing (which will be described later) of determining the state of the operation panel 2 based on electrical signals input from the detection sensor 130, the detection sensor 131, and the detection sensor 132.

The detection sensor 130 as a state change portion is provided in the operation panel storage portion 6, and the state changes according to the position of the operation panel 2. The detection sensor 130 is a photosensor such as a photointerrupter including a light receiving portion 1162a and a light emitting portion 1163a.

The light receiving portion 1162a includes a phototransistor (not illustrated) inside. In the transmissive state where there is no light shielding member 71 between the light emitting portion 1163a and the light receiving portion 1162a, the light receiving portion 1162a receives light emitted from the light emitting portion 1163a to output a Low-level signal to the controller 10. In the light shielding state where the light shielding member 71 is provided between the light emitting portion 1163a and the light receiving portion 1162a, the light receiving portion 1162a cannot receive the light emitted from the light emitting portion 1163a, and thus, outputs a High-level signal to the controller 10.

The light emitting portion 1163a includes an LED (not illustrated) therein. The light emitting portion 1163a emits light from the LED.

The detection sensor 131 as the state change portion is provided in the operation panel storage portion 6 and is provided at a position different from the detection sensor 130 and the detection sensor 132 in the movement direction of the operation panel 2, and the state changes according to the position of the operation panel 2. The detection sensor 131 is a photosensor such as a photointerrupter including a light receiving portion 1162b and a light emitting portion 1163b.

The light receiving portion 1162b includes a phototransistor (not illustrated) inside. In the transmissive state where there is no light shielding member 71 between the light emitting portion 1163b and the light receiving portion 1162b, the light receiving portion 1162b receives light emitted from the light emitting portion 1163b to output a Low-level signal to the controller 10. In the light shielding state where the light shielding member 71 is provided between the light emitting portion 1163b and the light receiving portion 1162b, the light receiving portion 1162b cannot receive the light emitted from the light emitting portion 1163b, and thus, outputs a High-level signal to the controller 10.

The light emitting portion 1163b includes an LED (not illustrated) therein. The light emitting portion 1163b emits light from the LED.

The detection sensor 132 as the state change unit is provided in the operation panel storage portion 6 and is provided at a position different from the detection sensor 130 and the detection sensor 131 in the movement direction of the operation panel 2, and the state changes according to the position of the operation panel 2. The detection sensor 132 is a photosensor such as a photointerrupter including a light receiving portion 1162c and a light emitting portion 1163c.

The light receiving portion 1162c includes a phototransistor (not illustrated) inside. In the transmissive state where there is no light shielding member 71 between the light emitting portion 1163c and the light receiving portion 1162c, the light receiving portion 1162c receives light emitted from the light emitting portion 1163c to output a Low-level signal to the controller 10. In the light shielding state where the light shielding member 71 is provided between the light emitting portion 1163c and the light receiving portion 1162c, the light receiving portion 1162c cannot receive the light emitted from the light emitting portion 1163c, and thus, outputs a High-level signal to the controller 10.

The light emitting portion 1163c includes an LED (not illustrated) therein. The light emitting portion 1163c emits light from the LED.

The operation of the image forming apparatus 1b according to the present embodiment is the same as the operation of the image forming apparatus 1a, and thus the description thereof will be omitted. In addition, the control according to the state of the operation panel 2 of the image forming apparatus 1b according to the present embodiment is the same control as the control according to the state of the operation panel 2 of the image forming apparatus 1a, and thus the description thereof will be omitted.

### State Detection Method for Operation Panel

A state detection method for the operation panel 2 of the image forming apparatus 1b according to the second embodiment of the present invention will be described in detail with reference to FIG. 8.

The states of the detection sensor 130, the detection sensor 131, and the detection sensor 132 change from the transmissive state to the light shielding state or from the light shielding state to the transmissive state by the light shielding member 71 that moves in conjunction with the movement of the operation panel 2. The CPU 100 determines the position and the state of the operation panel 2 based on the states of the detection sensor 130, the detection sensor 131, and the detection sensor 132.

Specifically, when the operation panel 2 is in the exposed state illustrated in FIG. 8A, the light shielding member 71 is located on the pull-out direction side with respect to the detection sensor 130, the detection sensor 131, and the detection sensor 132. As a result, the light shielding member 71 brings the detection sensor 130, the detection sensor 131, and the detection sensor 132 into the transmissive state.

The detection sensor 130 in the transmissive state does not detect the light shielding member 71 because light emitted from the light emitting portion 1163a is received by the light receiving portion 1162a without being blocked by the light shielding member 71. The detection sensor 131 in the transmissive state does not detect the light shielding member 71 because the light emitted from the light emitting portion 1163b is received by the light receiving portion 1162b without being blocked by the light shielding member 71. Further, the detection sensor 132 in the transmissive state does not detect the light shielding member 71 because the light emitted from the light emitting portion 1163c is received by the light receiving portion 1162c without being blocked by the light shielding member 71.

As a result, the detection sensor 130, the detection sensor 131, and the detection sensor 132 output a Low-level signal to the CPU 100. When the Low-level signal is input from the detection sensor 130, the detection sensor 131, and the detection sensor 132, the CPU 100 detects that the detection sensor 130, the detection sensor 131, and the detection sensor 132 are in the transmissive state. The CPU 100 determines that the operation panel 2 is in the exposed state.

When the operation panel 2 is in the third intermediate state illustrated in FIG. 8B, the light shielding member 71 brings the detection sensor 130 into the light shielding state and brings the detection sensor 131 and the detection sensor 132 into the transmissive state. The detection sensor 130 in the light shielding state detects the light shielding member 71 by the light shielding member 71 shielding the light emitted from the light emitting portion 1163a. The detection sensor 131 in the transmissive state does not detect the light shielding member 71 because the light emitted from the light emitting portion 1163b is received by the light receiving portion 1162b without being blocked by the light shielding member 71. Further, the detection sensor 132 in the transmissive state does not detect the light shielding member 71 because the light emitted from the light emitting portion 1163c is received by the light receiving portion 1162c without being blocked by the light shielding member 71.

As a result, the detection sensor 130 outputs a High-level signal to the CPU 100, and the detection sensor 131 and the detection sensor 132 output a Low-level signal to the CPU 100. When a High-level signal is input from the detection sensor 130, the CPU 100 detects that the detection sensor 130 is in the light shielding state. When the Low-level signal is input from the detection sensor 131 and the detection sensor 132, the CPU 100 detects that the detection sensor 131 and the detection sensor 132 are in the transmissive state. The CPU 100 determines that the operation panel 2 is in the third intermediate state.

When the operation panel 2 is in the fourth intermediate state illustrated in FIG. 8C, the light shielding member 71 brings the detection sensor 130 and the detection sensor 131 into the light shielding state and brings the detection sensor 132 into the transmissive state. The detection sensor 130 in the light shielding state detects the light shielding member 71 by the light shielding member 71 shielding the light emitted from the light emitting portion 1163a. The detection sensor 131 in the light shielding state detects the light shielding member 71 by the light shielding member 71 shielding the light emitted from the light emitting portion 1163b. Further, the detection sensor 132 in the transmissive state does not detect the light shielding member 71 because the light emitted from the light emitting portion 1163c is received by the light receiving portion 1162c without being blocked by the light shielding member 71.

As a result, the detection sensor 130 and the detection sensor 131 output a High-level signal to the CPU 100, and the detection sensor 132 outputs a Low-level signal to the CPU 100. When the High-level signal is input from the detection sensor 130 and the detection sensor 131, the CPU 100 detects that the detection sensor 130 and the detection sensor 131 are in the light shielding state. When the Low-level signal is input from the detection sensor 132, the CPU 100 detects that the detection sensor 132 is in the transmissive state. The CPU 100 determines that the operation panel 2 is in the fourth intermediate state.

When the operation panel 2 is in the fifth intermediate state illustrated in FIG. 9A, the light shielding member 71 brings the detection sensor 130, the detection sensor 131, and the detection sensor 132 into the light shielding state. The detection sensor 130 in the light shielding state detects the light shielding member 71 by the light shielding member 71 shielding the light emitted from the light emitting portion 1163a. The detection sensor 131 in the light shielding state detects the light shielding member 71 by the light shielding member 71 shielding the light emitted from the light emitting portion 1163b. Furthermore, the detection sensor 132 in the light shielding state detects the light shielding member 71 by the light shielding member 71 shielding the light emitted from the light emitting portion 1163c.

As a result, the detection sensor 130, the detection sensor 131, and the detection sensor 132 output a High-level signal to the CPU 100. When the High-level signal is input from the detection sensor 130, the detection sensor 131, and the detection sensor 132, the CPU 100 detects that the detection sensor 130, the detection sensor 131, and the detection sensor 132 are in the light shielding state. The CPU 100 determines that the operation panel 2 is in the fifth intermediate state.

When the operation panel 2 is in the sixth intermediate state illustrated in FIG. 9B, the light shielding member 71 brings the detection sensor 130 into the transmissive state and brings the detection sensor 131 and the detection sensor 132 into the light shielding state. The detection sensor 130 in the transmissive state does not detect the light shielding member 71 because light emitted from the light emitting portion 1163a is received by the light receiving portion 1162a without being blocked by the light shielding member 71.

The detection sensor 131 in the light shielding state detects the light shielding member 71 by the light shielding member 71 shielding the light emitted from the light emitting portion 1163b. Further, the detection sensor 132 in the light shielding state does not detect the light shielding member 71 because the light emitted from the light emitting portion 1163c is received by the light receiving portion 1162c without being blocked by the light shielding member 71.

As a result, the detection sensor 130 outputs a Low-level signal to the CPU 100, and the detection sensor 131 and the detection sensor 132 output a High-level signal to the CPU 100. When the Low-level signal is input from the detection sensor 130, the CPU 100 detects that the detection sensor 130 is in the transmissive state. When the High-level signal is input from the detection sensor 131 and the detection sensor 132, the CPU 100 detects that the detection sensor 131 and the detection sensor 132 are in the light shielding state. The CPU 100 determines that the operation panel 2 is in the sixth intermediate state.

When the operation panel 2 is in the stored state illustrated in FIG. 9C, the light shielding member 71 brings the detection sensor 130 and the detection sensor 131 into the transmissive state and brings the detection sensor 132 into the light shielding state. The detection sensor 130 in the transmissive state does not detect the light shielding member 71 because light emitted from the light emitting portion 1163a is received by the light receiving portion 1162a without being blocked by the light shielding member 71. The detection sensor 131 in the transmissive state does not detect the light shielding member 71 because the light emitted from the light emitting portion 1163b is received by the light receiving portion 1162b without being blocked by the light shielding member 71. Furthermore, the detection sensor 132 in the light shielding state detects the light shielding member 71 by the light shielding member 71 shielding the light emitted from the light emitting portion 1163c.

As a result, the detection sensor 130 and the detection sensor 131 output a Low-level signal to the CPU 100, and the detection sensor 132 outputs a High-level signal to the CPU 100. When the Low-level signal is input from the detection sensor 130 and the detection sensor 131, the CPU 100 detects that the detection sensor 130 and the detection sensor 131 are in the transmissive state. When the High-level signal is input from the detection sensor 132, the CPU 100 detects that the detection sensor 132 is in the light shielding state. The CPU 100 determines that the operation panel 2 is in the stored state.

As described above, since the position and the state of the operation panel 2 are detected in a digital format by the detection sensor 130, the detection sensor 131, and the detection sensor 132 which are photosensors, it is possible to suppress erroneous detection due to the influence of disturbance or the like.

### Panel State Detection Processing

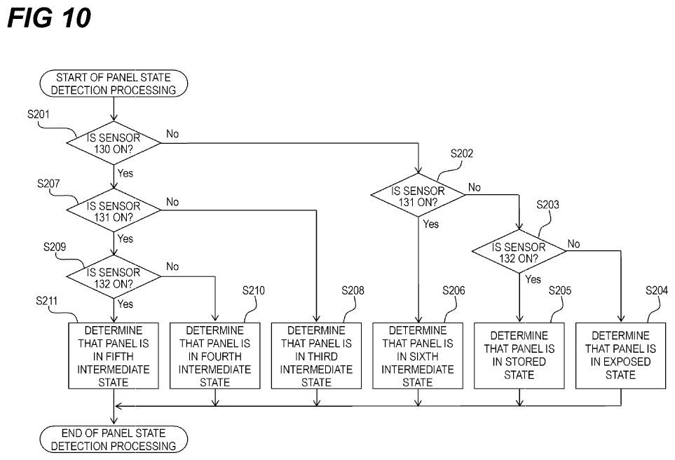

Panel state detection processing performed by the image forming apparatus 1b according to the second embodiment of the present invention will be described in detail with reference to FIG. 10.

The panel state detection processing illustrated in FIG. 10 is started at a timing when the main power source of the image forming apparatus 1b is turned on. In FIG. 10, the detection of the light shielding member 71 by each of the detection sensor 130, the detection sensor 131, and the detection sensor 132 is described as ON.

First, the CPU 100 determines whether or not the detection sensor 130 detects the light shielding member 71 (whether or not it is ON) (S201).

When the detection sensor 130 does not detect the light shielding member 71 (Step S201: No), the CPU 100 determines whether or not the detection sensor 131 detects the light shielding member 71 (S202).

When the detection sensor 131 does not detect the light shielding member 71 (Step S202: No), the CPU 100 determines whether or not the detection sensor 132 detects the light shielding member 71 (S203).

When the detection sensor 132 does not detect the light shielding member 71 (Step 203: No), the CPU 100 determines that the operation panel 2 is in the exposed state (S204), and then, ends the panel state detection processing.

On the other hand, when the detection sensor 132 detects the light shielding member 71 in the process of Step S203 (Step S203: Yes), the CPU 100 determines that the operation panel 2 is in the stored state (S205), and then, ends the panel state detection processing.

When the detection sensor 131 detects the light shielding member 71 in the process of Step S202 (Step S202: Yes), the CPU 100 determines that the operation panel 2 is in the sixth intermediate state (S206), and then ends the panel state detection processing.

When the detection sensor 130 detects the light shielding member 71 in the process of Step S201 (Step S201: Yes), the CPU 100 determines whether or not the detection sensor 131 detects the light shielding member 71 (S207).

When the detection sensor 131 does not detect the light shielding member 71 (Step S207: No), the CPU 100 determines that the operation panel 2 is in the third intermediate state (S208), and then ends the panel state detection processing.

On the other hand, when the detection sensor 131 detects the light shielding member 71 in the process of Step S207 (Step S207: Yes), the CPU 100 determines whether or not the detection sensor 132 detects the light shielding member 71 (S209).

When the detection sensor 132 does not detect the light shielding member 71 (Step S209: No), the CPU 100 determines that the operation panel 2 is in the fourth intermediate state (S210), and then ends the panel state detection processing.

On the other hand, when the detection sensor 132 detects the light shielding member 71 in the process of Step S209 (Step S209: Yes), the CPU 100 determines that the operation panel 2 is in the fifth intermediate state (S211), and then, ends the panel state detection processing.

In the present embodiment, the detection sensor 130, the detection sensor 131, and the detection sensor 132 whose states change according to the exposed position, the stored position, and the intermediate position of the operation panel 2 are provided. In addition, the CPU 100 that determines the exposed state, the stored state, or the intermediate state of the operation panel 2 based on changes in the states of the detection sensor 130, the detection sensor 131, and the detection sensor 132 is provided. As a result, it is possible to detect that the operation panel 2 is located at the stored position or the exposed position and to detect that the operation panel 2 is located between the exposed position and the stored position.

### Third Embodiment

A configuration of an image forming system according to a third embodiment of the present invention is the same as that in FIG. 2, and thus the description thereof will be omitted.

### Configuration of Image Forming Apparatus

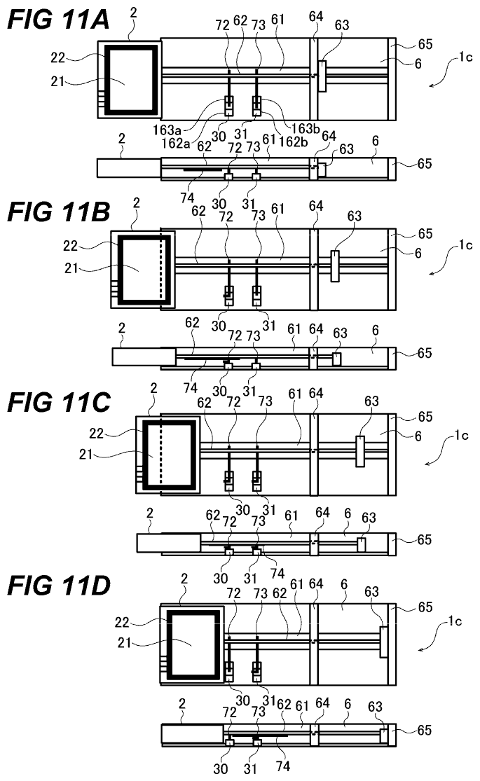

A configuration of an image forming apparatus 1c according to the third embodiment of the present invention will be described in detail with reference to FIGS. 11, 17B, and 17C. FIG. 17B is a diagram illustrating a relationship between a light shielding member 72 and a light shielding member 73, and a detection sensor 30 and a detection sensor 31 of the image forming apparatus 1c according to the present embodiment.

In FIG. 11, the same components as those in FIG. 6 are denoted by the same reference signs, and the description thereof will be omitted. The configuration of the image forming apparatus 1c according to the present embodiment other than the components in FIGS. 11, 17B, and 17C is the same as that of FIGS. 1 to 3, and thus illustration and description thereof will be omitted. Further, in FIG. 11, a key input portion 25 on the operation panel 2 is not illustrated.

In FIG. 11, FIG. 11A illustrates the exposed state where an operation panel 2 is located at the exposed position. FIG. 11B illustrates a first intermediate state where the operation panel 2 is located at an intermediate position between the exposed position and the stored position and the exposure amount of the operation panel 2 is large. FIG. 11C illustrates a second intermediate state where the operation panel 2 moves from the intermediate position illustrated in FIG. 11B in the direction further approaching the stored position and is located at the intermediate position, and the exposure amount of the operation panel 2 is small. FIG. 11D illustrates the stored state where the operation panel 2 is located at the stored position.

The image forming apparatus 1c includes the operation panel 2, an operation panel storage portion 6, a controller 10, a storage device 11, a power source device 12, a fixing portion 13, a reader 14, an image forming portion 15, a sheet cassette 19A, and a sheet cassette 19B. The image forming apparatus 1c further includes the detection sensor 30, the detection sensor 31, an operation portion rail 61, a fixing member 63, an abutment member 64, and an abutment member 65. The image forming apparatus 1c further includes the light shielding member 72, the light shielding member 73, a sheet discharge tray 161a, a sheet discharge tray 161b, and a shaft portion 162.

The controller 10 controls the overall operation of the image forming apparatus 1c, the operation of a processing device 16, and the operation of a notification device 17.

The storage device 11 stores various programs 110 related to the control of the image forming apparatus 1c, display image data, print data, and the like.

In a mode setting processing, the CPU 100 shifts the image forming apparatus 1c from a standby mode to a sleep mode with low power consumption, according to a count value counted by a timer 102.

A light receiving portion 162a includes a phototransistor (not illustrated) inside. In the transmissive state where there is no light shielding member 72 between a light emitting portion 163a and the light receiving portion 162a, the light receiving portion 162a receives and detects light emitted from the light emitting portion 163a, thereby outputting a Low-level signal to the controller 10. In the light shielding state where the light shielding member 72 is provided between the light emitting portion 163a and the light receiving portion 162a, the light receiving portion 162a cannot receive and detect the light emitted from the light emitting portion 163a, and thus, outputs a High-level signal to the controller 10.

A light receiving portion 162b includes a phototransistor (not illustrated) inside. In the transmissive state where there is no light shielding member 73 between a light emitting portion 163b and the light receiving portion 162b, the light receiving portion 162b receives and detects light emitted from the light emitting portion 163b, thereby outputting a Low-level signal to the controller 10. In the light shielding state where the light shielding member 73 is provided between the light emitting portion 163b and the light receiving portion 162b, the light receiving portion 162b cannot receive and detect the light emitted from the light emitting portion 163b, and thus, outputs a High-level signal to the controller 10.

The light shielding member 72 is provided above the operation portion rail 61 and is rotatably supported by a bearing (not illustrated) of the operation panel storage portion 6. As illustrated in FIGS. 17B and 17C, the light shielding member 72 includes a flag portion 72a and a flag portion 72b provided between the light receiving portion 162a and the light emitting portion 163a in the detection sensor 30 to be retractable between the light receiving portion 162a and the light emitting portion 163a. The light shielding member 72 is biased by a biasing member (not illustrated) such that the flag portion 72b is located between the light receiving portion 162a and the light emitting portion 163a.

The light shielding member 73 is provided above the operation portion rail 61 and is rotatably supported by a bearing (not illustrated) of the operation panel storage portion 6. The light shielding member 73 is provided at a position different from the light shielding member 72 in the movement direction of the operation panel 2. The light shielding member 73 includes a flag portion 73a and a flag portion 73b provided between the light receiving portion 162b and the light emitting portion 163b in the detection sensor 31 to be retractable between the light receiving portion 162b and the light emitting portion 163b. The light shielding member 73 is biased by a biasing member (not illustrated) such that the flag portion 73b is located between the light receiving portion 162b and the light emitting portion 163b.

The shaft portion 162 includes a protruding portion 74 that abuts on the flag portion 72a of the light shielding member 72 or the flag portion 73a of the light shielding member 73 according to the position of the operation panel 2. The operation panel 2 is connected to the shaft portion 162. The shaft portion 162 moves together with the operation panel 2.

The operation of the image forming apparatus 1c according to the present embodiment is the same as the operation of the image forming apparatus 1a, and thus the description thereof will be omitted. In addition, control according to the state of the operation panel 2 of the image forming apparatus 1c according to the present embodiment is the same control as the control according to the state of the operation panel 2 of the image forming apparatus 1a, and thus the description thereof will be omitted.

### State Detection Method for Operation Panel

A state detection method for the operation panel 2 of the image forming apparatus 1c according to the third embodiment of the present invention will be described in detail with reference to FIG. 11.

The state of the detection sensor 30 changes from the transmissive state to the light shielding state or from the light shielding state to the transmissive state by the light shielding member 72 that rotates in conjunction with the movement of the operation panel 2. The state of the detection sensor 31 changes from the transmissive state to the light shielding state or from the light shielding state to the transmissive state by the light shielding member 73 that rotates in conjunction with the movement of the operation panel 2.

Specifically, the operation panel 2 moves to an intermediate position to be a first intermediate state illustrated in FIG. 11B by moving from the exposed position which is the exposed state illustrated in FIG. 11A in the push-in direction. At this time, the protruding portion 74 moves from a position on the pull-out direction side with respect to the detection sensor 30 and the detection sensor 31 to above the light shielding member 72.

As a result, the protruding portion 74 abuts on the flag portion 72a of the light shielding member 72 and presses the flag portion 72a in the push-in direction (the arrow direction in FIG. 17B) against a biasing force of the biasing member. Further, the protruding portion 74 rotates the light shielding member 72 from a state illustrated in FIG. 17B to a state illustrated in FIG. 17C, and maintains a state of rotating. The light shielding member 72 maintains the rotated state, so that the flag portion 72b is retracted from between the light receiving portion 162a and the light emitting portion 163a, and the detection sensor 30 is turned into the transmissive state.

The operation panel 2 moves to an intermediate position to be a second intermediate state illustrated in FIG. 11C by further moving in the push-in direction from the intermediate position that is the first intermediate state illustrated in FIG. 11B. At this time, the protruding portion 74 moves to above the light shielding member 73.

As a result, the protruding portion 74 maintains the light shielding member 72 in the rotated state illustrated in FIG. 17C against the biasing force of the biasing member. In addition, the protruding portion 74 abuts on the flag portion 73a of the light shielding member 73 to press the flag portion 73a in the push-in direction against the biasing force of the biasing member, thereby rotating the light shielding member 73 and maintaining the state of rotating. The light shielding member 72 maintains the rotated state, so that the flag portion 72b is retracted from between the light receiving portion 162a and the light emitting portion 163a, and the detection sensor 30 is turned into the transmissive state. The light shielding member 73 maintains the rotated state, so that the flag portion 73b is retracted from between the light receiving portion 162b and the light emitting portion 163b, and the detection sensor 31 is turned into the transmissive state.

The operation panel 2 moves to the stored position that is the stored state illustrated in FIG. 11D by further moving in the push-in direction from the intermediate position that is the second intermediate state illustrated in FIG. 11C. At this time, the protruding portion 74 passes through the light shielding member 72.

As a result, the protruding portion 74 releases the pressing against the light shielding member 72 and maintains the light shielding member 73 in a state of being rotated against the biasing force of the biasing member. When the pressing by the protruding portion 74 is released, the light shielding member 72 rotates from the state illustrated in FIG. 17C to the state illustrated in FIG. 17B by the biasing force of the biasing member, and the flag portion 72b is located between the light receiving portion 162a and the light emitting portion 163a. The light shielding member 73 maintains the rotated state, so that the flag portion 73b is retracted from between the light receiving portion 162b and the light emitting portion 163b, and the detection sensor 31 is turned into the transmissive state.

When the operation panel 2 moves in the pull-out direction from the stored position that is the stored state illustrated in FIG. 11D and moves to the exposed position to be the exposed state illustrated in FIG. 11A, the opposite operation is performed.

Here, when the operation panel 2 is in the exposed state illustrated in FIG. 11A, the light shielding member 72 brings the detection sensor 30 into the light shielding state, and the light shielding member 73 brings the detection sensor 31 into the light shielding state. The detection sensor 30 in the light shielding state detects the light shielding member 72 by the flag portion 72b of the light shielding member 72 blocking the light emitted from the light emitting portion 163a. The detection sensor 31 in the light shielding state detects the light shielding member 73 by the flag portion 73b of the light shielding member 73 blocking the light emitted from the light emitting portion 163b.

As a result, the detection sensor 30 and the detection sensor 31 output a High-level signal to the CPU 100. When the High-level signal is input from the detection sensor 30 and the detection sensor 31, the CPU 100 detects that the detection sensor 30 and the detection sensor 31 are in the light shielding state, and determines that the operation panel 2 is in the exposed state.

When the operation panel 2 is in the first intermediate state illustrated in FIG. 11B, the light shielding member 72 maintains a state of being pressed by the protruding portion 74 and being rotated, thereby bringing the detection sensor 30 into the transmissive state, and the light shielding member 73 brings the detection sensor 31 into the light shielding state. The detection sensor 30 in the transmissive state does not detect the light shielding member 72 because the light emitted from the light emitting portion 163a is received by the light receiving portion 162a without being blocked by the light shielding member 72. The detection sensor 31 in the light shielding state detects the light shielding member 73 by the flag portion 73b of the light shielding member 73 blocking the light emitted from the light emitting portion 163b.

As a result, the detection sensor 30 outputs a Low-level signal to the CPU 100, and the detection sensor 31 outputs a High-level signal to the CPU 100. The CPU 100 detects that the detection sensor 30 is in the transmissive state when the Low-level signal is input from the detection sensor 30, and detects that the detection sensor 31 is in the light shielding state when the High-level signal is input from the detection sensor 31. As a result, the CPU 100 determines that the operation panel 2 is in the first intermediate state.

When the operation panel 2 is in the second intermediate state illustrated in FIG. 11C, the light shielding member 72 maintains the state of being pressed by the protruding portion 74 and being rotated, thereby bringing the detection sensor 30 into the transmissive state. The light shielding member 73 maintains the state of being pressed by the protruding portion 74 and being rotated, thereby bringing the detection sensor 31 into the transmissive state. The detection sensor 30 in the transmissive state does not detect the light shielding member 72 because the light emitted from the light emitting portion 163a is received by the light receiving portion 162a without being blocked by the light shielding member 72. The detection sensor 31 in the transmissive state does not detect the light shielding member 73 because the light emitted from the light emitting portion 163b is received by the light receiving portion 162b without being blocked by the flag portion 73b of the light shielding member 73.

As a result, the detection sensor 30 and the detection sensor 31 output a Low-level signal to the CPU 100. When the Low-level signal is input from the detection sensor 30 and the detection sensor 31, the CPU 100 detects that the detection sensor 30 and the detection sensor 31 are in the transmissive state, and determines that the operation panel 2 is in the second intermediate state.

When the operation panel 2 is in the stored state illustrated in FIG. 11D, the light shielding member 72 is rotated by the protruding portion 74 releasing the pressing, and thus brings the detection sensor 30 into the light shielding state. The light shielding member 73 maintains the state of being pressed by the protruding portion 74 and being rotated, thereby bringing the detection sensor 31 into the transmissive state. The detection sensor 30 in the light shielding state detects the light shielding member 72 by the flag portion 72b of the light shielding member 72 blocking the light emitted from the light emitting portion 163a. The detection sensor 31 in the transmissive state does not detect the light shielding member 73 because the light emitted from the light emitting portion 163b is received by the light receiving portion 162b without being blocked by the flag portion 73b of the light shielding member 73.

As a result, the detection sensor 30 outputs a High-level signal to the CPU 100, and the detection sensor 31 outputs a Low-level signal to the CPU 100. The CPU 100 detects that the detection sensor 30 is in the light shielding state when the High-level signal is input from the detection sensor 30, and detects that the detection sensor 31 is in the transmissive state when the Low-level signal is input from the detection sensor 31. As a result, the CPU 100 determines that the operation panel 2 is in the stored state.

As described above, the light shielding member 72 or light shielding member 73 rotates by the protruding portion 74 that moves in conjunction with the movement of the operation panel 2, so that the states of the detection sensor 30 and the detection sensor 31 change from the transmissive state to the light shielding state or from the light shielding state to the transmissive state.

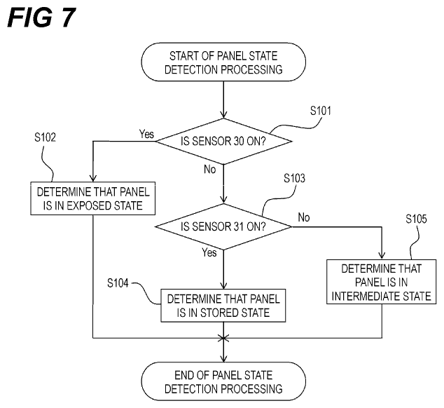

Panel state detection processing performed by the image forming apparatus 1c according to the present embodiment is the same as the processing in FIG. 7, and thus the description thereof will be omitted.

### Fourth Embodiment

A configuration of an image forming system according to a fourth embodiment of the present invention is the same as that in FIG. 2, and thus the description thereof will be omitted.

### Configuration of Image Forming Apparatus

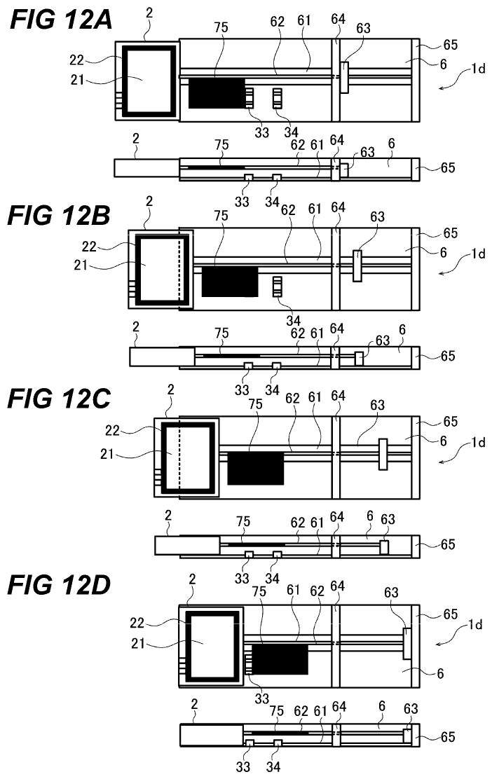

A configuration of an image forming apparatus 1d according to the fourth embodiment of the present invention will be described in detail with reference to FIGS. 12 and 17D. FIG. 17D is a perspective view of a detection sensor 33 and a detection sensor 34 of the image forming apparatus 1d according to the present embodiment.

In FIG. 12, the same components as those in FIG. 6 are denoted by the same reference signs, and the description thereof will be omitted. The configuration of the image forming apparatus 1d according to the present embodiment other than the components in FIG. 11 is the same as that of FIGS. 1 to 3, and thus illustration and description thereof will be omitted. In FIG. 12, a key input portion 25 on an operation panel 2 is not illustrated.

In FIG. 12, FIG. 12A illustrates the exposed state where the operation panel 2 is located at the exposed position. FIG. 12B illustrates a first intermediate state where the operation panel 2 is located at an intermediate position between the exposed position and the stored position and the exposure amount of the operation panel 2 is large. FIG. 12C illustrates a second intermediate state where the operation panel 2 moves from the intermediate position illustrated in FIG. 12B in the direction further approaching the stored position and is located at an intermediate position, and the exposure amount of the operation panel 2 is small. FIG. 12D illustrates the stored state where the operation panel 2 is located at the stored position.

The image forming apparatus 1d includes the operation panel 2, an operation panel storage portion 6, a controller 10, a storage device 11, a power source device 12, a fixing portion 13, a reader 14, an image forming portion 15, a sheet cassette 19A, and a sheet cassette 19B. The image forming apparatus 1d further includes the detection sensor 33, the detection sensor 34, an operation portion rail 61, a shaft portion 62, a fixing member 63, an abutment member 64, an abutment member 65, a reflecting plate 75, a sheet discharge tray 161a, and a sheet discharge tray 161b.

The controller 10 controls the overall operation of the image forming apparatus 1d, the operation of a processing device 16, and the operation of a notification device 17.

In a mode setting processing, the CPU 100 shifts the image forming apparatus 1d from a standby mode to a sleep mode with low power consumption, according to a count value counted by a timer 102.

The CPU 100 performs panel state detection processing of determining the state of the operation panel 2 based on electrical signals input from the detection sensor 33 and the detection sensor 34.

The storage device 11 stores various programs 110 related to the control of the image forming apparatus 1d, display image data, print data, and the like.

The detection sensor 33 and the detection sensor 34 as a state change portion are provided in the operation panel storage portion 6, and the state changes according to the position of the operation panel 2. As illustrated in FIG. 17D, the detection sensor 33 and the detection sensor 34 are reflective sensors each including an LED 165, a phototransistor 166, an irradiation window 167, and a light receiving window 168.

The LED 165 is a light source that emits light. When the reflecting plate 75 is located above the detection sensor 33 or the detection sensor 34, the LED 165 irradiates the reflecting plate 75 with the emitted light through the irradiation window 167.

The phototransistor 166 can receive light guided and emitted from the light receiving window 168, and outputs a High-level electric signal to the CPU 100 when receiving light, and outputs a Low-level electric signal to the CPU 100 when not receiving light.

The irradiation window 167 emits the light emitted from the LED 165 to the outside of the detection sensor 33 or the detection sensor 34.

When the reflecting plate 75 is located above the detection sensor 33 or the detection sensor 34, the light receiving window 168 guides the reflected light reflected by the reflecting plate 75 to the inside of the detection sensor 33 or the detection sensor 34 to irradiate the phototransistor 166 with the guided light.

The shaft portion 62 is connected to the operation panel 2 and is provided with the reflecting plate 75. The shaft portion 62 moves together with the operation panel 2.

The reflecting plate 75 reflects light emitted from the LED 165 of the detection sensor 33 or the detection sensor 34 and emitted through the irradiation window 167 according to the position in the Y-direction. The reflecting plate 75 irradiates the phototransistor 166 of the detection sensor 33 or the detection sensor 34 with the reflected light through the light receiving window 168.

The operation of the image forming apparatus 1d according to the present embodiment is the same as the operation of the image forming apparatus 1a, and thus the description thereof will be omitted. In addition, control according to the state of the operation panel 2 of the image forming apparatus 1d according to the present embodiment is the same control as the control according to the state of the operation panel 2 of the image forming apparatus 1a, and thus the description thereof will be omitted.

### State Detection Method for Operation Panel

A state detection method for the operation panel 2 of the image forming apparatus 1d according to the fourth embodiment of the present invention will be described in detail with reference to FIG. 12.

The state of the detection sensor 33 changes from a light receiving state to a non-light receiving state or from the non-light receiving state to the light receiving state by the reflecting plate 75 that moves in conjunction with the movement of the operation panel 2. The state of the detection sensor 34 changes from the light receiving state to the non-light receiving state or from the non-light receiving state to the light receiving state by the reflecting plate 75 that moves in conjunction with the movement of the operation panel 2. The CPU 100 detects the position and the state of the operation panel 2 based on the detection results of the detection sensor 33 and the detection sensor 34 indicating the light receiving state or the non-light receiving state.

Specifically, when the operation panel 2 is in the exposed state illustrated in FIG. 12A, the reflecting plate 75 is located in the pull-out direction side with respect to the detection sensor 30 and the detection sensor 31, and is not located above the detection sensor 33 and the detection sensor 34. As a result, the reflecting plate 75 brings the detection sensor 33 and the detection sensor 34 into the non-light receiving state.

Each of the phototransistor 166 of the detection sensor 33 in the non-light receiving state and the phototransistor 166 of the detection sensor 34 in the non-light receiving state outputs a Low-level signal to the CPU 100. When the Low-level signal is input from the detection sensor 33 and the detection sensor 34, the CPU 100 detects that the detection sensor 33 and the detection sensor 34 are in the non-light receiving state, and determines that the operation panel 2 is in the exposed state.

When the operation panel 2 is in the first intermediate state illustrated in FIG. 12B, the reflecting plate 75 is located above the detection sensor 33 to bring the detection sensor 33 into the light receiving state. The reflecting plate 75 is not located above the detection sensor 34 to bring the detection sensor 34 into the non-light receiving state.

The phototransistor 166 of the detection sensor 33 in the light receiving state outputs a High-level signal to the CPU 100, and the phototransistor 166 of the detection sensor 34 in the non-light receiving state outputs a Low-level signal to the CPU 100. The CPU 100 detects that the detection sensor 33 is in the light receiving state when the High-level signal is input from the detection sensor 33, and detects that the detection sensor 34 is in the non-light receiving state when the Low-level signal is input from the detection sensor 34. As a result, the CPU 100 determines that the operation panel 2 is in the first intermediate state.

When the operation panel 2 is in the second intermediate state illustrated in FIG. 12C, the reflecting plate 75 is located above the detection sensor 33 and the detection sensor 34, and thus, brings the detection sensor 33 and the detection sensor 34 into the light receiving state.

Each of the phototransistor 166 of the detection sensor 33 in the light receiving state and the phototransistor 166 of the detection sensor 34 in the light receiving state outputs a High-level signal to the CPU 100. When the High-level signal is input from the detection sensor 33 and the detection sensor 34, the CPU 100 detects that the detection sensor 33 and the detection sensor 34 are in the light receiving state, and determines that the operation panel 2 is in the second intermediate state.

When the operation panel 2 is in the stored state illustrated in FIG. 12D, the reflecting plate 75 is not located above the detection sensor 33 to bring the detection sensor 33 into the non-light receiving state, and is located above the detection sensor 34 to bring the detection sensor 34 into the light receiving state.

The phototransistor 166 of the detection sensor 33 in the non-light receiving state outputs a Low-level signal to the CPU 100, and the phototransistor 166 of the detection sensor 34 in the light receiving state outputs a High-level signal to the CPU 100. The CPU 100 detects that the detection sensor 33 is in the non-light receiving state when the Low-level signal is input from the detection sensor 33, and detects that the detection sensor 34 is in the light receiving state when the High-level signal is input from the detection sensor 34. As a result, the CPU 100 determines that the operation panel 2 is in the stored state.

As described above, since the position and the state of the operation panel 2 are detected in a digital format by the detection sensor 33 and the detection sensor 34 which are reflective sensors, it is possible to suppress erroneous detection due to the influence of disturbance or the like.

Panel state detection processing performed by the image forming apparatus 1d according to the present embodiment is the same as the processing in FIG. 7, and thus the description thereof will be omitted.

### Fifth Embodiment

A configuration of an image forming system according to a fifth embodiment of the present invention is the same as that in FIG. 2, and thus the description thereof will be omitted.

### Configuration of Image Forming Apparatus

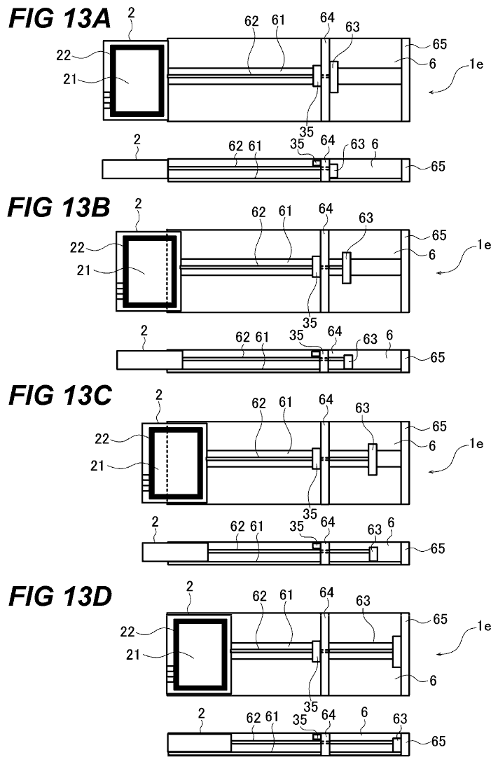

A configuration of an image forming apparatus 1e according to the fifth embodiment of the present invention will be described in detail with reference to FIGS. 13 and 17E. FIG. 17E is a perspective view of a distance measuring sensor 35 of the image forming apparatus 1e according to the present embodiment.

In FIG. 13, the same components as those in FIG. 6 are denoted by the same reference signs, and the description thereof will be omitted. The configuration of the image forming apparatus 1e according to the present embodiment other than the components in FIG. 13 is the same as that of FIGS. 1 to 3, and thus illustration and description thereof will be omitted. In FIG. 13, a key input portion 25 on an operation panel 2 is not illustrated.

In FIG. 13, FIG. 13A illustrates the exposed state where the operation panel 2 is located at the exposed position. FIG. 13B illustrates a first intermediate state where the operation panel 2 is located at an intermediate position between the exposed position and the stored position and the exposure amount of the operation panel 2 is large. FIG. 13C illustrates a second intermediate state where the operation panel 2 moves from the intermediate position illustrated in FIG. 13B in the direction further approaching the stored position and is located at an intermediate position, and the exposure amount of the operation panel 2 is small. FIG. 13D illustrates the stored state where the operation panel 2 is located at the stored position.

The image forming apparatus 1e includes the operation panel 2, an operation panel storage portion 6, a controller 10, a storage device 11, a power source device 12, a fixing portion 13, a reader 14, an image forming portion 15, a sheet cassette 19A, and a sheet cassette 19B. The image forming apparatus 1e further includes the distance measuring sensor 35, an operation portion rail 61, a shaft portion 62, a fixing member 63, an abutment member 64, an abutment member 65, a sheet discharge tray 161a, and a sheet discharge tray 161b.

The controller 10 controls the overall operation of the image forming apparatus 1e, the operation of a processing device 16, and the operation of a notification device 17.

In a mode setting processing, the CPU 100 shifts the image forming apparatus 1e from a standby mode to a sleep mode with low power consumption, according to a count value counted by a timer 102.

The CPU 100 performs panel state detection processing (which will be described later) of determining the state of the operation panel 2 based on an electrical signal input from the distance measuring sensor 35.

The storage device 11 stores various programs 110 related to the control of the image forming apparatus 1e, display image data, print data, and the like.

The distance measuring sensor 35 as the state change portion is provided in the abutment member 64 inside the operation panel storage portion 6, and the state changes according to the position of the operation panel 2. The position of the distance measuring sensor 35 does not change in conjunction with the movement of the operation panel 2. As illustrated in FIG. 17E, the distance measuring sensor 35 includes a transmission portion 169 and a reception portion 170.

The transmission portion 169 includes a light emitting lens 171 and an LED (not illustrated). The transmission portion 169 emits light from the LED via the light emitting lens 171.

The reception portion 170 includes a light receiving lens 172 and a photodiode (not illustrated). The reception portion 170 detects reflected light of light emitted from the transmission portion 169 via the light receiving lens 172, and outputs an electric signal corresponding to the detection result to the CPU 100.

The operation of the image forming apparatus 1e according to the present embodiment is the same as the operation of the image forming apparatus 1a, and thus the description thereof will be omitted. In addition, control according to the state of the operation panel 2 of the image forming apparatus 1e according to the present embodiment is the same control as the control according to the state of the operation panel 2 of the image forming apparatus 1a, and thus the description thereof will be omitted.

### State Detection Method for Operation Panel

A state detection method for the operation panel 2 of the image forming apparatus 1e according to the fifth embodiment of the present invention will be described in detail with reference to FIG. 13.

The distance measuring sensor 35 receives the pulsed light that has been emitted from the LED of the transmission portion 169 and reflected by the operation panel 2, by a photodiode via the light receiving lens 172 of the reception portion 170. The distance measuring sensor 35 changes to a state of approaching the operation panel 2 as the operation panel 2 approaches the stored position from the exposed position, and changes to a state of being separated from the operation panel 2 as the operation panel 2 approaches the exposed position from the stored position.

The CPU 100 measures the time from the emission of the pulsed light from the distance measuring sensor 35 to the reception of the reflected light of the pulsed light, and calculates the distance between the distance measuring sensor 35 and the operation panel 2 based on the measured time, thereby detecting the position and the state of the operation panel 2. Here, the distance between the distance measuring sensor 35 and the operation panel 2 is 100 when the operation panel 2 is in the exposed state, and is 0 when the operation panel 2 is in the stored state. The distance between the distance measuring sensor 35 and the operation panel 2 is not limited to the above value, and can be set to a value corresponding to the accuracy of the distance measuring sensor 35 to be used.

Specifically, when the operation panel 2 is in the exposed state illustrated in FIG. 13A, the CPU 100 calculates 100 as the distance between the distance measuring sensor 35 and the operation panel 2 based on the electric signal input from the distance measuring sensor 35. The CPU 100 determines that the operation panel 2 is in the exposed state.

When the operation panel 2 is in the first intermediate state illustrated in FIG. 13B, the CPU 100 calculates 75 as the distance between the distance measuring sensor 35 and the operation panel 2 based on the electric signal input from the distance measuring sensor 35. The CPU 100 determines that the operation panel 2 is in the first intermediate state.

When the operation panel 2 is in the second intermediate state illustrated in FIG. 13C, the CPU 100 calculates 25 as the distance between the distance measuring sensor 35 and the operation panel 2 based on the electric signal input from the distance measuring sensor 35. The CPU 100 determines that the operation panel 2 is in the second intermediate state.

When the operation panel 2 is in the stored state illustrated in FIG. 13D, the CPU 100 calculates 0 as the distance between the distance measuring sensor 35 and the operation panel 2 based on the electric signal input from the distance measuring sensor 35. The CPU 100 determines that the operation panel 2 is in the stored state.

As described above, since the position and the state of the operation panel 2 are detected by the distance measuring sensor 35 in an analog format, it is possible to accurately detect the position and the state of the operation panel 2.

### Panel State Detection Processing

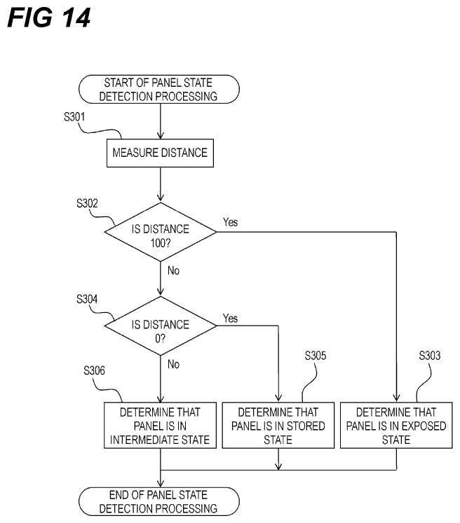

Panel state detection processing performed by the image forming apparatus 1e according to the fifth embodiment of the present invention will be described in detail with reference to FIG. 14.

The panel state detection processing illustrated in FIG. 14 is started at a timing when the main power source of the image forming apparatus 1e is turned on.

First, the CPU 100 calculates and measures the distance between the distance measuring sensor 35 and the operation panel 2 based on the electric signal input from the distance measuring sensor 35 (S301).

Then, the CPU 100 determines whether or not the measured distance is 100 (S302).

When the measured distance is 100 (Step S302: Yes), the CPU 100 determines that the operation panel 2 is in the exposed state (S303), and then, ends the panel state detection processing.

On the other hand, when the measured distance is a value other than 100 (Step S302: No), the CPU 100 determines whether or not the measured distance is 0 (S304).

When the measured distance is 0 (Step S304: Yes), the CPU 100 determines that the operation panel 2 is in the stored state (S305), and then, ends the panel state detection processing.

On the other hand, when the measured distance is a value other than 0 (Step S304: No), the CPU 100 determines that the operation panel 2 is in the first intermediate state or the second intermediate state (S306), and then ends the panel state detection processing.

In the process of Step S306 in the panel state detection processing described above, whether the operation panel 2 is in the first intermediate state or the second intermediate state may be determined based on the measured distance.

Furthermore, in the above-described embodiment, light is used when the distance measuring sensor 35 measures the distance, but the present invention is not limited thereto, and the distance may be measured by using ultrasonic waves or the like other than the light.

### Sixth Embodiment

A configuration of an image forming system according to a sixth embodiment of the present invention is the same as that in FIG. 2, and thus the description thereof will be omitted.

### Configuration of Image Forming Apparatus

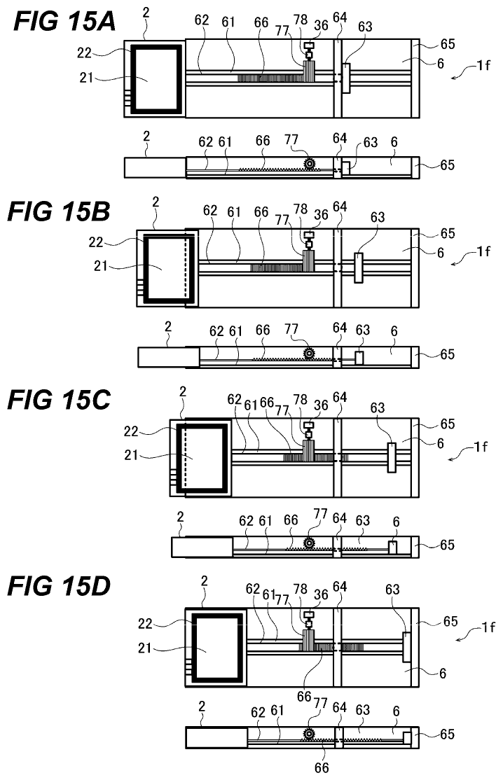

A configuration of an image forming apparatus 1f according to the sixth embodiment of the present invention will be described in detail with reference to FIG. 15. In FIG. 15, the same components as those in FIG. 6 are denoted by the same reference signs, and the description thereof will be omitted. The configuration of the image forming apparatus 1f according to the present embodiment other than the components in FIG. 15 is the same as that of FIGS. 1 to 3, and thus illustration and description thereof will be omitted. In FIG. 15, a key input portion 25 on an operation panel 2 is not illustrated.

In FIG. 15, FIG. 15A illustrates the exposed state where the operation panel 2 is located at the exposed position. FIG. 15B illustrates a first intermediate state where the operation panel 2 is located at an intermediate position between the exposed position and the stored position and the exposure amount of the operation panel 2 is large. FIG. 15C illustrates a second intermediate state where the operation panel 2 moves from the intermediate position illustrated in FIG. 15B in the direction further approaching the stored position and is located at an intermediate position, and the exposure amount of the operation panel 2 is small. FIG. 15D illustrates the stored state where the operation panel 2 is located at the stored position.

The image forming apparatus 1f includes the operation panel 2, an operation panel storage portion 6, a controller 10, a storage device 11, a power source device 12, a fixing portion 13, a reader 14, an image forming portion 15, a sheet cassette 19A, and a sheet cassette 19B. The image forming apparatus 1f further includes an operation portion rail 61, a shaft portion 62, a fixing member 63, an abutment member 64, and an abutment member 65. The image forming apparatus 1f further includes a rack gear portion 66, a gear 77, a joining shaft 78, a rotary encoder 79, a sheet discharge tray 161a, and a sheet discharge tray 161b.

The operation panel storage portion 6 is provided in a space below the reader 14 in an apparatus body 50 of the image forming apparatus 1f.

The controller 10 controls the overall operation of the image forming apparatus 1f, the operation of a processing device 16, and the operation of a notification device 17.

In a mode setting processing, the CPU 100 shifts the image forming apparatus 1f from a standby mode to a sleep mode with low power consumption, according to a count value counted by a timer 102. The CPU 100 performs panel state detection processing (which will be described later) of determining the state of the operation panel 2 based on an electrical signal input from the rotary encoder 79.

The storage device 11 stores various programs 110 related to the control of the image forming apparatus 1f, display image data, print data, and the like.

The rack gear portion 66 is provided at the shaft portion 62. The rack gear portion 66 moves together with the shaft portion 62.

The gear 77 as the state change portion does not move even though the operation panel 2 moves. The gear 77 meshes with the rack gear portion 66, rotates by the movement of the rack gear portion 66, and turns into a state where a rotation amount changes according to the position of the operation panel 2.

The joining shaft 78 couples the gear 77 and the rotary encoder 79.

The rotary encoder 79 is provided in the operation panel storage portion 6 and does not move even though the operation panel 2 moves. The rotary encoder 79 detects the rotation amount and a rotation direction (CW direction or CCW direction) of the gear 77, and outputs an electric signal corresponding to the detection result of the detected rotation amount and rotation direction of the gear 77 to the CPU 100.

In the sheet discharge tray 161a, the sheet S to which the toner image conveyed by the fixing portion 13 is fixed is discharged as it is via the processing device 16 or not via the processing device 16.

In the sheet discharge tray 161b, the sheet S to which the toner image conveyed by the fixing portion 13 is fixed is discharged as it is via the processing device 16 or not via the processing device 16.

The operation of the image forming apparatus 1f according to the present embodiment is the same as the operation of the image forming apparatus 1a, and thus the description thereof will be omitted. In addition, control according to the state of the operation panel 2 of the image forming apparatus 1f according to the present embodiment is the same control as the control according to the state of the operation panel 2 of the image forming apparatus 1a, and thus the description thereof will be omitted.

### State Detection Method for Operation Panel

A state detection method for the operation panel 2 of the image forming apparatus 1f according to the sixth embodiment of the present invention will be described in detail with reference to FIG. 15.

The rotary encoder 79 rotates in the CW direction when the operation panel 2 moves from the exposed position that is the exposed state to the stored position that is the stored state, and rotates in the CCW direction opposite to the CW direction when the operation panel 2 moves from the stored position that is the stored state to the exposed position that is the exposed state. The state of the gear 77 changes to a state where the rotation amount in the CW direction increases as the operation panel 2 approaches the stored position from the exposed position, and changes to a state where the rotation amount in the CCW direction increases as the operation panel 2 approaches the exposed position from the stored position.

The CPU 100 counts up according to the rotation amount when the rotary encoder 79 rotates in the CW direction, and counts down according to the rotation amount when the rotary encoder 79 rotates in the CCW direction. Here, the rotation amount of the rotary encoder 79 is 100 when the operation panel 2 is in the stored state, and is 0 when the operation panel 2 is in the exposed state. The rotation amount of the rotary encoder 79 is not limited to the above value, and can be set to a value corresponding to the accuracy of the rotary encoder 79 to be used.

Specifically, when the operation panel 2 is in the exposed state illustrated in FIG. 15A, the CPU 100 counts based on the electric signal input from the rotary encoder 79 and calculates 0 as the rotation amount of the gear 77. The CPU 100 determines that the operation panel 2 is in the exposed state.

When the operation panel 2 is in the first intermediate state illustrated in FIG. 15B, the CPU 100 counts based on the electric signal input from the rotary encoder 79 and calculates 25 as the rotation amount of the gear 77. The CPU 100 determines that the operation panel 2 is in the first intermediate state.

When the operation panel 2 is in the second intermediate state illustrated in FIG. 15C, the CPU 100 counts based on the electric signal input from the rotary encoder 79 and calculates 75 as the rotation amount of the gear 77. The CPU 100 determines that the operation panel 2 is in the second intermediate state.

When the operation panel 2 is in the stored state illustrated in FIG. 15D, the CPU 100 counts based on the electric signal input from the rotary encoder 79 and calculates 100 as the rotation amount of the gear 77. The CPU 100 determines that the operation panel 2 is in the stored state.

As described above, since the position and the state of the operation panel 2 are detected by the rotary encoder 79 in an analog format, it is possible to accurately detect the position and the state of the operation panel 2.

### Panel State Detection Processing

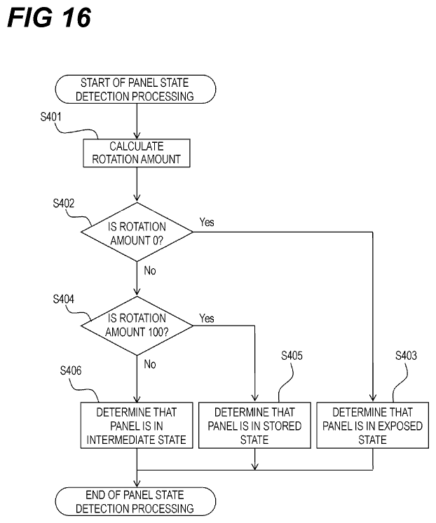

Panel state detection processing performed by the image forming apparatus 1f according to the sixth embodiment of the present invention will be described in detail with reference to FIG. 16.

The panel state detection processing illustrated in FIG. 16 is started at a timing when the main power source of the image forming apparatus 1f is turned on.

First, the CPU 100 calculates and measures the rotation amount of the gear 77 based on the electric signal input from the rotary encoder 79 (S401).

Then, the CPU 100 determines whether or not the measured rotation amount is 100 (S402).

When the measured rotation amount is 100 (Step S402: Yes), the CPU 100 determines that the operation panel 2 is in the stored state (S403), and then, ends the panel state detection processing.

On the other hand, when the measured rotation amount is a value other than 100 (Step S402: No), the CPU 100 determines whether or not the measured rotation amount is 0 (S404).

When the measured rotation amount is 0 (Step S404: Yes), the CPU 100 determines that the operation panel 2 is in the exposed state (S405), and then, ends the panel state detection processing.

On the other hand, when the measured rotation amount is a value other than 0 (Step S404: No), the CPU 100 determines that the operation panel 2 is in the first intermediate state or the second intermediate state (S406), and then ends the panel state detection processing.

In the process of Step S406 in the panel state detection processing described above, whether the operation panel 2 is in the first intermediate state or the second intermediate state may be determined based on the measured rotation amount.

In the present embodiment, the rack gear portion 66 and the gear 77 are used, but the present invention is not limited thereto. A motor may be used instead of the rack gear portion 66 and the gear 77. In this case, the operation panel 2 can be automatically moved by the motor, and the position of the operation panel 2 can be detected by the rotary encoder 79.

The present invention is not limited to the above embodiments, and various modifications can be made without departing from the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-47849, filed Mar. 25, 2024, which is hereby incorporated by reference herein in its entirety.

What is claimed is:

1. An image forming apparatus that forms an image on a recording material, the image forming apparatus comprising:
an apparatus body including an image forming portion configured to form an image on a recording material;
an operation panel including a display portion configured to display information regarding image formation, the operation panel being provided in the apparatus body to be movable between an exposed position, where the entirety of the display portion is exposed to an outside of the apparatus body and a stored position, where the entirety of the display portion is stored in the apparatus body so as not to be visible from the outside of the apparatus body, the operation panel can be positioned at an intermediate position between the exposed position and the stored position, where a portion of the operation panel is stored in the apparatus body;
a state change portion configured to change a state according to the exposed position, the stored position, and the intermediate position of the operation panel; and
a controller configured to determine the exposed position, the stored position, or the intermediate position of the operation panel based on the state of the state change portion.

2. The image forming apparatus according to claim 1, wherein
the operation panel
reaches the stored position via the intermediate position by moving from the exposed position in one direction, and
reaches the exposed position via the intermediate position by moving from the stored position in a direction opposite to the one direction.

3. The image forming apparatus according to claim 1, wherein
the operation panel includes an operable operation panel, and
the stored position is a position where the entirety of the operation panel is not visible.

4. The image forming apparatus according to claim 1, wherein
the operation panel includes an operable operation panel, and
the exposed position is a position where the entirety of the operation panel is visible.

5. The image forming apparatus according to claim 1, wherein
the operation panel includes an operable operation panel, and
the intermediate position is a position where a portion of the operation panel is visible.

6. The image forming apparatus according to claim 1, further comprising:
a power source portion configured to supply power to the operation panel, wherein
the operation panel includes a display portion configured to display a predetermined image, and
the power source portion supplies power to the display portion or stops the supply of the power according to the exposed position, the intermediate position, and the stored position.

7. The image forming apparatus according to claim 1, further comprising:
a power source portion configured to supply power to the operation panel, wherein
the operation panel includes a touch panel, and
the power source portion supplies power to the touch panel or stops the supply of the power according to the exposed position, the intermediate position, and the stored position.

8. The image forming apparatus according to claim 1, wherein
the operation panel includes a display portion configured to display a predetermined image and change a display mode of the image according to the stored position, the exposed position, and the intermediate position.

9. The image forming apparatus according to claim 1, wherein
the state change portion includes a first state change portion and a second state change portion arranged along a movement direction of the operation panel, and
the controller determines which one of a plurality of different intermediate positions the operation panel is in, based on a state of the first state change portion and a state of the second state change portion.
